(19) United States
(12) Patent Application Publication
(10) Pub. No.: US 2026/0194376 A1
(43) Pub. Date: Jul. 9, 2026

(54) DEVICES AND SYSTEMS FOR MEASURING FLUID FLOW

(71) Applicant: EM-TEC GMBH, Finning (DE)

(72) Inventors: Joerg Meier, Finning (DE); Markus Ewen, Finning (DE); Robert Kamberger, Finning (DE); Sergej Krutsch, Finning (DE); Stefan Schaetzl, Finning (DE); Michael Geier, Finning (DE); Christian Vohburger, Finning (DE); Alexey Govorukhin, Finning (DE)

(21) Appl. No.: 19/126,047

(22) PCT Filed: Oct. 31, 2022
(86) PCT No.: PCT/EP2022/080394

§ 371 Date: Apr. 30, 2025

(51) Int. Cl. G01F 1/66; G01F 1/667; G01F 15/14

(52) U.S. Cl. CPC G01F 1/662; G01F 1/667; G01F 15/14

(57) ABSTRACT

Devices and systems for measuring fluid flow. A measuring device (1000) configured for coupling to a control device (2000) comprises a fluid conduit (1200), a first electrical connector (1480, 1480′, 1480″), a first ultrasound transducer (1410) and a second ultrasound transducer (1420), each electrically connected to the first electrical connector, and an acoustic coupling medium (1140) coupling the first and second ultrasound transducers (1410, 1420) to the fluid conduit. The first ultrasound transducer is configured to emit, in response to receiving a control signal, an ultrasound signal along a sound path (1160) extending through the acoustic coupling medium from the first ultrasound transducer to the second ultrasound transducer. The second ultrasound transducer is configured to receive an ultrasound signal transmitted along the sound path and to generate a measurement signal based on the received ultrasound signal wherein the fluid conduit is disposed at least in part along the sound path such that the emitted ultrasound signal propagates along the sound path and strikes, in a measurement section (1230) of the fluid conduit, a medium to be measured. A control device (2000) comprises a housing (2100) including a coupling portion (2300) configured for receiving a measuring device (1000), a second electrical connector (2280, 2280′, 2280″), an electronic control unit (2200), ECU, electrically connected to the second electrical connector and configured for sending one or more control signals to the measuring device and for receiving one or more measurement signals from to the measuring device. A system (100) comprises a measuring device (1000) and a control device (2000).

### TECHNICAL FIELD

This specification relates to devices and systems for measuring fluid flow.

### BACKGROUND

Flow meters are used for measuring an amount of fluid flowing through, for example, a section of tubing of a fluid line or fluid circuit. The fluid to be measured can generally include, for example, liquids, gases, and combinations thereof. Fluid flow can be measured based on different principles, for example, using mechanical flow meters, pressure-based flow meters, electromagnetic flow meters, and ultrasonic flow meters, among others. The different principles have properties that are more or less well suited for different applications. Some applications require measurement of large quantities of fluid, other applications require high precision, yet other applications require the fluid lines and flow meters to fulfill particular requirements regarding sterilization, etc.

In some examples, a flow meter is configured to receive a fluid line in a corresponding recess (e.g., a “clamp-on” flow meter) and has one or more sensors that determine fluid flow through the material of the fluid line. The characteristics of fluid flow measurement using clamp-on flow meters may depend on several factors, including the properties of the material of the fluid line (e.g., abrasion resistance, hardness, flexibility, durability), the properties of fluid flow through the fluid line (e.g., viscosity, pressure, temperature, variations thereof), and operational characteristics of the fluid system (e.g., vibrations). Therefore, the quality of fluid flow measurement using clamp-on flow meters may vary depending these and other factors.

Further, flexible fluid lines for use with clamp-on flow meters are typically limited in terms of maximum pressure of the fluid to be measured. In some examples, reinforced fluid lines are used for applications involving higher pressure fluids. However, such reinforcements may negatively affect fluid flow measurement, for example, when reinforcement measures (e.g. fabric, strengthened materials, increased wall thickness) dampen or otherwise affect signals used for measuring fluid flow. This can lead to insufficient reproducibility of fluid flow measurements.

### SUMMARY

In general, one innovative aspect of the subject matter described in this specification can be embodied in a measuring device configured for coupling to a control device. The measuring device comprises a fluid conduit, a first electrical connector, a first ultrasound transducer and a second ultrasound transducer, each electrically connected to the first electrical connector, and an acoustic coupling medium coupling the first and second ultrasound transducers to the fluid conduit. The first ultrasound transducer is configured to emit, in response to receiving a control signal, an ultrasound signal along a sound path extending through the acoustic coupling medium from the first ultrasound transducer to the second ultrasound transducer. The second ultrasound transducer is configured to receive an ultrasound signal transmitted along the sound path and to generate a measurement signal based on the received ultrasound signal. The fluid conduit is disposed at least in part along the sound path such that the emitted ultrasound signal propagates along the sound path and strikes, in a measurement section of the fluid conduit, a medium to be measured.

In a 2^{nd} aspect according to aspect 1, the acoustic coupling medium includes a first portion a second portion. The first portion couples the first ultrasound transducer to the fluid conduit and the second portion couples the second ultrasound transducer to the fluid conduit.

In a 3^{rd} aspect according to aspect 2, the measuring device further comprises air backings positioned adjacent to the fluid conduit and separating the first portion of the acoustic coupling medium and the second portion of the acoustic coupling medium from one another.

In a 4^{th} aspect according to aspect 3, the air backings are configured to acoustically decouple the first portion of the acoustic coupling medium from the second portion of the acoustic coupling medium, such that ultrasounds signals propagating along the sound path do not propagate directly from the first portion into the second portion.

In a 5^{th} aspect according to any one of aspects 2 to 4, the sound path extends from the first ultrasound transducer to the second ultrasound transducer through the first portion of the acoustic coupling medium, through measurement section, and through the second portion of the acoustic coupling medium.

In a 6^{th} aspect according to any one of the preceding aspects, the acoustic coupling medium comprises thermoplastic material. Preferably, the thermoplastic material includes epoxy resin and/or is substantially homogeneous.

In a 7^{th} aspect according to any one of the preceding aspects, the measuring device further comprises a printed circuit board, PCB, including the first electrical connector and configured to electrically connect the first and second ultrasound transducers to the first electrical connector.

In an 8^{th} aspect according to aspect 7, each of the first and second ultrasound transducers is mechanically connected to the PCB.

In a 9^{th} aspect according to aspect 7, the first ultrasound transducer and the first connecting portion of the first ultrasound transducer form a first transducer module the second ultrasound transducer and the second connecting portion of the second ultrasound transducer form a second transducer module.

In a 10^{th} aspect according to aspect 9, the first connecting portion and the second connecting portion of the PCB are configure to electrically and mechanically connect the first and second ultrasound transducers to the PCB.

In an 11^{th} aspect according to any one of aspects 7 to 10, the first connecting portion and the second connecting portion of the PCB are configure to electrically and mechanically connect the first and second ultrasound transducers to the PCB.

In a 12^{th} aspect according to any one of aspects 7 to 11, the first electrical connector comprises one or more of a USB-C connector, a USB-A connector, a USB-B connector, a Micro USB connector, a Mini USB connector, an HDMI connector, and a SUB-D connector.

In a 13^{th} aspect according to any one of aspects 1 to 11, the first electrical connector comprises a first coil and a second coil.

In a 14^{th} aspect according to aspect 13, the first coil is configured to inductively couple to a first coil of a control device and the second coil is configured to inductively couple to a second coil of the control device.

In a 15^{th} aspect according to aspect 14, the first electrical connector comprises a third coil configured to inductively couple to a third coil of the control device.

In a 16^{th} aspect according to any one of the preceding aspects in combination with aspects 7 and 13, the PCB includes the first coil of the first electrical connector and the second coil of the first electrical connector, and optionally the third coil of the first electrical connector.

In a 17^{th} aspect according to any one of the preceding aspects, the first electrical connector is configured to distribute electrical signals. Optionally, the electrical signals include control signals and measurement signals.

In an eighteenth aspect according to any one of the preceding aspects, the first electrical connector is configured to connect to a second electrical connector of a control device.

In a 19^{th} aspect according to any one of the preceding aspects, the first ultrasound transducer is configured to receive the control signal from a control device through the first electrical connector. Additionally or alternatively, the second ultrasound transducer is configured to transmit the measurement signal to the control device through the first electrical connector.

In a 20^{th} aspect according to any one of the preceding aspects, the measuring device further comprises one or more sensors. The one or more sensors include one or more of a temperature sensor, a pressure sensor, an electrical conductivity sensor, and an optical sensor.

In a 21^{st} aspect according to any one of the preceding aspects, an inner diameter of the fluid conduit is in a range of 0.1 to and 0.5 inch (0.254 to 1.27 cm). Preferably, the inner diameter is 0.25 inch (0.635 cm). Alternatively, the inner diameter of the fluid conduit is in a range of 0.5 to 1.5 inches (1.27 to 3.81 cm). Preferably, the inner diameter is 1 inch (2.54 cm).

In a 22^{nd} aspect according to any one of the preceding aspects, the fluid conduit has a first end and a second end in fluid communication with one another and configured to attach to a fluid circuit.

In a 23^{rd} aspect according to the preceding aspect, the first end and/or the second end includes one of the following: a sanitary connector, an Aseptic Quick Connector, and an MPX Insert.

In a 24^{th} aspect according to any one of the preceding aspects, the measuring device further comprises a main body.

In a 25^{th} aspect according to the preceding aspect, the main body includes a coupling portion configured for coupling the measuring device to a control device.

In a 26^{th} aspect according to any one of the preceding aspects 24 or 25, the main body defines the fluid conduit as an integral portion thereof.

In a 27^{th} aspect according to any one of the preceding aspects 24 to 26, the main body is configured to fixedly position the PCB relative to the fluid conduit.

In a 28^{th} aspect according to any one of the preceding aspects, the first ultrasound transducer and the second ultrasound transducer are fixedly positioned relative to the fluid conduit by the acoustic coupling medium.

In a 29^{th} aspect according to any one of the preceding aspects, the measuring device is configured for applications in the medical and/or pharmaceutical field.

In a 30^{th} aspect, another innovative aspect of the subject matter described in this specification can be embodied in a control device comprising a housing including a coupling portion configured for receiving a measuring device, a second electrical connector, an electronic control unit, ECU, electrically connected to the second electrical connector and configured for sending one or more control signals to the measuring device and for receiving one or more measurement signals from to the measuring device.

In a 31^{st} aspect according to the preceding aspect, the coupling portion comprises a locking mechanism configured to selectively lock a measuring device in a coupled position when coupled to the control device, or to selectively unlock the measuring device.

In a 32^{nd} aspect according to the preceding aspect, the locking mechanism comprises a Bayonet-type locking mechanism.

In a 33^{rd} aspect according to any one of the preceding aspects 31 or 32, further comprising a switch configured to selectively lock and unlock the locking mechanism. Optionally, selectively locking and unlocking includes haptic and/or audible feedback.

In a 34^{th} aspect according to any one of the preceding aspects 30 to 33, the control device further comprises a cover configured to cover at least part of the coupling portion.

In a 35^{th} aspect according to the preceding aspect, the cover is configured to cover the second electrical connector in the absence of a measuring device coupled to the control device.

In a 36^{th} aspect according to any one of the preceding aspects 30 to 35, the control device further comprises a status indicator connected to the ECU and configured to indicate an operating status of the control device and/or an operating status of a measuring device when coupled to the control device.

In a 37^{th} aspect according to any one of the preceding aspects 30 to 36, the second electrical connector is configured to distribute electrical signals. Optionally, the electrical signals include control signals and measurement signals.

In a 38^{th} aspect according to any one of the preceding aspects 30 to 37, when a measuring device is coupled to the control device, the control device is configured to send a control signal to the control device, and receive a measurement signal from the measuring device, the measurement signal indicating properties of fluid flow in a measurement section of a fluid conduit of the measuring device.

In a 39^{th} aspect according to any one of the preceding aspects 30 to 38, the second electrical connector comprises one or more of a USB-C connector, a USB-A connector, a USB-B connector, a Micro USB connector, a Mini USB connector, an HDMI connector, and a SUB-D connector.

In a 40^{th} aspect according to any one of the preceding aspects 30 to 39, the second electrical connector comprises a first coil and a second coil.

In a 41^{st} aspect according to any one of the preceding aspects 30 to 40, the first coil is configured to inductively couple to a first coil of a measuring device and the second coil is configured to inductively couple to a second coil of the measuring device.

In a 42^{nd} aspect according to any one of the preceding aspects 30 to 41, the first electrical connector comprises a third coil configured to inductively couple to a third coil of the measuring device.

In a 43^{rd} aspect according to any one of the preceding aspects 30 to 42, the control device is configured to determine on or more of a presence of a coupled measuring device, an operating status of a coupled measuring device, and a type of a couple measuring device based on an inductive coupling of the third coils of the control device and of the measuring device.

In a 44^{th} aspect according to any one of the preceding aspects 30 to 43, the ECU includes the first coil of the second electrical connector and the second coil of the second electrical connector, and optionally the third coil of the second electrical connector.

In a 45^{th} aspect according to any one of the preceding aspects 30 to 44, the second electrical connector is configured to distribute electrical signals. Optionally, the electrical signals include control signals and measurement signals.

In a 46^{th} aspect according to any one of the preceding aspects 30 to 45, the second electrical connector is configured to connect to a first electrical connector of a measuring device.

In a 47^{th} aspect according to any one of the preceding aspects 30 to 46, the ECU comprises functionality to control one or more sensors of a measuring device and to receive measurement signals for the one or more sensors. The one or more sensor include one or more of a temperature sensor, a pressure sensor, an electrical conductivity sensor, and an optical sensor.

In a 48^{th} aspect according to any one of the preceding aspects 30 to 47, the control device is at least in part made of components comprising stainless steel.

In a 49^{th} aspect according to any one of the preceding aspects 30 to 48, the control device is configured for applications in the medical and/or pharmaceutical field.

In a 50^{th} aspect, another innovative aspect of the subject matter described in this specification can be embodied in a system for measuring fluid flow. The system comprises a measuring device according to any one of aspects 1 to 29 and a control device according to any one of aspects 30 to 49.

In a 51^{st} aspect, another innovative aspect of the subject matter described in this specification can be embodied in a method for manufacturing a measuring device according to any one of aspects 1 to 29. The method comprises preparing inner surfaces of a main body of the measuring device for casting of thermoplastic resin, positioning a PBC of the measuring device relative to the main body, performing casting of the thermoplastic resin, and performing curing of the thermoplastic resin.

In a 52^{nd} aspect according to the preceding aspect 51, the method further comprises arranging a first ultrasound transducer and a second ultrasound transducer relative to the main body.

The foregoing and other embodiments can each optionally include one or more of the aforementioned features, alone or in combination. In particular, one embodiment includes all the following features in combination.

The subject matter described in this specification can be implemented in particular embodiments so as to realize one or more of the following advantages. A system and/or device for measuring fluid flow can be provided that facilitates more precise and/or reliable measurement of fluid flow. Further, a measuring device for measuring fluid flow can be provided that can be easily and reliably coupled to a control device for measuring fluid flow. Further, a control device for measuring fluid flow can be provided that can receive any one of a number of different measuring devices for measuring fluid flow. Further, a system and/or a control device for measuring fluid flow can be provided that can be maintained more easily and/or efficiently. Further, a system and/or a control device for measuring fluid flow can be provided that can be operated reliably over an extended period.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows a perspective view of a device for measuring fluid flow in accordance with embodiments of this specification;

FIG. 2 shows a perspective view of the measuring device for measuring fluid flow in accordance with embodiments of this specification;

FIG. 2A shows a partial side view of the printed circuit board shown in FIG. 2 in accordance with embodiments of this specification;

FIG. 3 shows a perspective view of a control device for measuring fluid flow in accordance with embodiments of this specification;

FIG. 3A shows a perspective view of a system for measuring fluid flow in accordance with embodiments of this specification;

FIG. 4A shows a perspective view of the control device for measuring fluid flow in accordance with embodiments of this specification;

FIG. 4B shows a perspective view of a control device for measuring fluid flow in accordance with embodiments of this specification;

FIG. 5 shows a cross-section view of a device for measuring fluid flow in accordance with a first embodiment of this specification;

FIG. 5A shows perspective front and back views of transducer modules in accordance with embodiments of this specification;

FIG. 5B shows a perspective view of transducer modules positioned on a PCB in accordance with embodiments of this specification;

FIG. 5C shows a top view of connectors positioned on a PCB and configured to receive transducer modules in accordance with embodiments of this specification;

FIG. 6 shows a cross-section view of a device for measuring fluid flow in accordance with a second embodiment of this specification;

FIG. 7 shows a cross-section view of a measuring device and a control device for measuring fluid flow in accordance with the first embodiment of this specification illustrating a second variant of the electrical connection;

FIG. 8 shows an electrical circuit diagram of an electrical connection for a measuring device and a control device for measuring fluid flow in accordance with the first embodiment of this specification;

FIG. 9 shows a cross-section view of a measuring device for measuring fluid flow in accordance with the first embodiment of this specification illustrating a third variant of the electrical connection;

FIG. 10 shows an electrical circuit diagram of an electrical circuit for detecting a measuring device in accordance with embodiments of this specification;

FIG. 11 shows an electrical circuit diagram of an electrical circuit for detecting a measuring device in accordance with embodiments of this specification;

FIG. 12A shows a bottom view of the measuring device for measuring fluid flow in accordance with embodiments of this specification;

FIG. 12B shows a perspective view of the control device for measuring fluid flow in accordance with embodiments of this specification;

FIG. 13 shows a diagram illustrating a process for determining pairs of ultrasound transducers for use according to embodiments of this specification;

FIG. 14 is a flowchart of an example process for manufacturing a measuring device 1000 in accordance with embodiments of this specification; and

FIG. 15 shows a cross-section view of a device for measuring fluid flow in accordance with the first embodiment of this specification.

Like reference numbers and designations in the various drawings indicate like elements.

### DETAILED DESCRIPTION

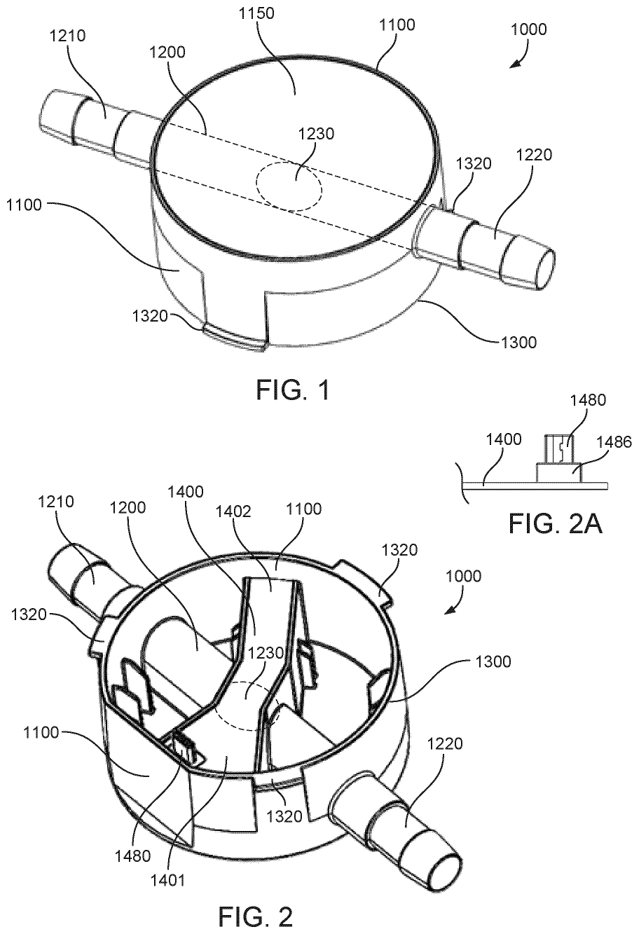

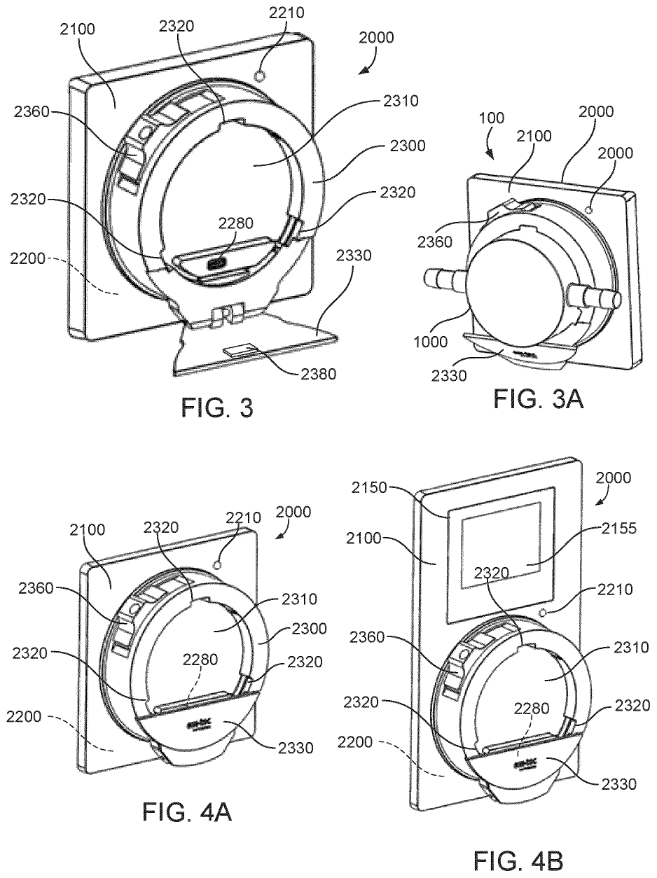

FIG. 1 shows a perspective view of a device 1000 for measuring fluid flow in accordance with embodiments of this specification. In this specification, device 1000 for measuring fluid flow may be referred to as “measuring” device 1000 or as “single-use” device 1000. As described further below, a system 100 for measuring fluid flow includes a measuring device 1000 (see, e.g., FIGS. 1, 2, 12A) and a control device 2000 (see, e.g., FIGS. 3, 4, 12B). Without general limitation, measuring device 1000 is designated for single use and/or for use over a limited period of time (e.g. a single or uninterrupted use extending over a period of one or more hours to one or more days). In some examples, measuring device 1000 is designated for single use of up to 30 days and cannot be reused. Without general limitation, control device 2000 is designated for multiple use and/or for (continuous) use over an extended period (e.g. several years of operation in combination with a plurality of single-use or measuring devices 1000). A detailed description of embodiments of measuring device 1000, control device 2000, and system 100 follows below.

FIG. 1 shows a perspective view of an outer side of measuring device 1000, where “outer” refers to a mounted configuration in which measuring device 1000 is coupled to a control device 2000 (not shown in FIG. 1). In some embodiments, control device 2000 is positioned with a mounting surface 2310 extending in a substantially vertical plane, such that the outer side of measuring device 1000 also extends in a substantially vertical plane. In such embodiments, the outer side faces away from mounting surface 2310 of control device 2000 (e.g. to the front, towards an operator of devices 1000, 2000).

In other embodiments, control device 2000 is positioned with mounting surface 2310 extending in a substantially horizontal plane, such that the outer side of measuring device 1000 also extends in a substantially horizontal plane. In such embodiments, the outer side faces away from mounting surface 2310 of control device 2000 (e.g., upwards, towards an operator of devices 1000, 2000).

Measuring device 1000 includes a main body 1100 that defines a fluid conduit 1200 having a respective first end 1210 and a respective second end 1220. Fluid conduit 1200 is configured to receive a fluid, e.g. a medium to be measured, at one of the first 1210 and second 1220 ends and to release the fluid at the other one of the first 1210 and second 1220 ends. In some embodiments the direction of fluid flow through fluid conduit 1200 has a preferred or required direction, e.g. from the first end 1210 to the second end 1220. Fluid conduit 1200 further includes a measurement section 1230 located between the first 1210 and second 1220 ends. In some embodiments, measurement section 1230 is located substantially in the center of main body 1100. FIG. 1 shows measurement section 1230 merely schematically for illustration purposes. Measurement section 1230 as schematically shown in FIG. 1 does not specifically limit size, shape, form, or location of measurement section 1230. In some embodiments, measurement section 1230 is substantially defined by the properties and arrangement of ultrasound transducers 1410, 1420 (not shown in FIG. 1) as described further below.

Depending on a respective application for measuring fluid flow, fluid conduit 1200 and/or other components of measuring device 1000 can be adapted accordingly. In one aspect, the dimensions of fluid conduit 1200 could be adapted to particular properties of the respective application for measuring fluid flow and/or the medium to be measured. For example, on the one hand, at low volume flows it can be difficult to achieve a desired resolution or precision of fluid flow measurement due to the fact that low flow velocities cannot be resolved well in time. On the other hand, at high volume flows, the dynamic pressure in the conduit can increase to an extent that may damage the fluid medium. The use of fluid conduits having different diameters can reduce or eliminate such effects arising from applications in which lower volumetric flow rates are to be measured or in which higher volumetric flow rates are to be measured.

For example, for applications in which lower volumetric flow rates are to be measured, measuring device 1000 can be provided with a main body 1100 defining a fluid conduit 1200 having a relatively small diameter. In some embodiments for measuring lower volumetric flow rates, the diameter of fluid conduit 1200 can be between 0.1 inch and 0.5 inch (between 0.254 cm and 1.27 cm), preferably 14 inch (0.635 cm). In some examples, lower volumetric flow rates refer to flow rates in a range between 1 ml/min and 8000 ml/min, depending on the inner diameter of fluid conduit 1200. For example, for applications in which higher volumetric flow rates are to be measured, measuring device 1000 can be provided with a main body 1100 defining a fluid conduit 1200 having a relatively larger diameter. In some embodiments for measuring higher volumetric flow rates, the diameter of fluid conduit 1200 can be between 0.5 inch and 1.5 inches (between 1.27 cm and 3.81 cm), preferably 1 inch (2.54 cm). In some examples, lower volumetric flow rates refer to flow rates in a range between 150 ml/min and 120000 ml/min, depending on the inner diameter of fluid conduit 1200.

Devices 1000 with a main body 1100 defining a fluid conduit 1200 having a relatively smaller diameter and employed for measuring lower volumetric flow rates typically exhibit a higher resolution or precision at such lower volumetric flow rates, e.g. 3% or lower, preferably 1% or lower. Such devices 1000 may not be able to measure higher volumetric flow rates due to the fluid flow being restricted by the relatively smaller diameter of fluid conduit 1200 and/or due to potential damage to the fluid medium to be measured cause by, e.g., excessive pressure.

Devices 1000 with a main body 1100 defining a fluid conduit 1200 having a relatively larger diameter and employed for measuring higher volumetric flow rates typically exhibit a lower resolution or precision at lower volumetric flow rates (e.g. at 250 ml/min or less). However, the resolution or precision of such devices 1000 typically increases when the volumetric flow rate increases. Such devices 1000 may be able to measure lower volumetric flow rates, albeit with a lower resolution or precision.

In some embodiments, fluid conduit 1200 has the form of a straight channel or pipe between respective first 1210 and second 1220 ends. This may reduce or eliminate perturbations in the flow profile of fluid through fluid conduit 1200.

First end 1210 and second end 1220 of fluid conduit 1200 are each configured to connect to a respective fluid line of a fluid circuit. To this aim, first end 1210 and second end 1220 of fluid conduit 1200 can be provided with a corresponding shape or connector. In the embodiment shown in FIGS. 1 and 2, first end 1210 and second end 1220 of fluid conduit 1200 have the form of a hose barb (or “single-barb”) configured receive or connect to a hose or flexible tubing. The use of hose barb connectors and corresponding flexible tubing may entail one or more of the following. Retroactively fitting of measuring device 1000 into a fluid circuit may lead to contamination of the fluid and/or circuit because connecting the tubing to the hose barb connectors requires opening of the circuit and attaching the tubing to the hose barb connectors. This can be avoided by using connectors that have a seal that is broken upon connection of the tubing to the device (e.g., Aseptic Quick Connector or MPX Insert). As another example, flexible tubing may be attached to measuring device 1000 in an undesired manner, e.g. involving an incomplete connection or a slanted or crooked extension of the tubing from the connector. In such cases, fluid flow through fluid conduit 1200 may be compromised, potentially leading to disturbances in the flow profile and/or increased shearing forces in the medium to be measured. This can negatively impact the measurements performed using measuring device 1000. In yet another example, in some applications not only the volumetric flow rate is to be measured, but also other properties of the medium to be measured are monitored, e.g. checking for a potential presence of air bubbles in the medium. In order to reliably detect air bubbles in the medium to be measured, fluid flow through fluid conduit 1200 should be free from perturbations and as smooth as possible.

In other embodiments, first end 1210 and second end 1220 of fluid conduit 1200 can be provided with corresponding connectors, including, but not limited to sanitary connectors, Aseptic Quick Connectors, MPX Inserts, and others.

In some embodiments, main body 1100 is provided with a cover 1150. Cover 1150 serves to protect an outer surface of measuring device 1000 and/or main body 1100. Additionally, cover 1150 may be provided with marking, labeling, or similar, indicative of properties of measuring device 1000 or usage instructions, etc.

FIG. 2 shows a perspective view of measuring device 1000 for measuring fluid flow in accordance with embodiments of this specification. FIG. 2 shows a perspective view of a coupling side of measuring device 1000, where “coupling side” refers to a mounted configuration in which measuring device 1000 is coupled to control device 2000 (not shown in FIG. 2). In some embodiments, control device 2000 is positioned with mounting surface 2310 extending in a substantially vertical plane, such that the coupling side of measuring device 1000 also substantially extends along a substantially vertical plane and faces mounting surface 2310 of control device 2000 (e.g. away from an operator of devices 1000, 2000).

In the embodiment shown in FIG. 2, main body 1100 has a coupling side 1300 that is provided with mounting means 1320 configured to engage with corresponding mounting means 2320 of a control device 2000 to which measuring device 1000 is configured to be mounted to. In the embodiment shown, mounting means 1320 include radially protruding projections configured to engage with mounting means 2320 of a control device 2000. In some embodiments, radially protruding projections are provided along a circumference of main body 1100. Distances between adjacent radially protruding projections may be configured to restrict insertion and/or mounting of measuring device 1000 solely in a single position and/or orientation with respect to mounting means 2320 of a control device 2000, in order to prevent incorrect or improper mounting of measuring device 1000.

FIG. 2 shows an example configuration of a printed circuit board (PCB) 1400 in relation to main body 1100. PCB 1400 is coupled to main body 1100 on a coupling side of measuring device 1000, facing mounting surface 2310 of control device 2000 when measuring device 1000 is coupled thereto. PCB 1400 is arranged relative to main body 1100 and fluid conduit 1200 such that PCB 1400 extends in a plane substantially parallel to a longitudinal axis of fluid conduit 1200, with first and second ends 1401, 1402 of PCB 1400 extending beyond fluid conduit 1200 when viewed from the coupling side of measuring device 1000. PCB 1400 is further arranged on the coupling side of measuring device 1000 facing mounting surface 2310 of control device 2000, when mounted thereto, between fluid conduit 1200 and the mounting surface 2310.

PCB 1400 includes an electrical connector 1480 configured for connecting to a corresponding electrical connector 2280 of control device 2000. In some embodiments, electrical connector 1480 extends from PCB 1400 in a direction substantially perpendicular to a plane of PCB 1400 and/or towards the coupling side of measuring device 1000. Electrical connector 1480 is generally configured to face mounting surface 2310 of control device 2000 when measuring device 1000 is coupled thereto such that upon mounting of measuring device 1000, according to a first variant, an electrical connection 1480, 2280 is achieved between electrical connector 1480 of measuring device 1000 and electrical connector 2280 of control device 2000.

In some embodiments, electrical connector 1480 can include a USB-C connector (e.g. a USB-C plug). Electrical connector 2280 can include a USB-C connector (e.g. a USB-C socket). Alternative electrical connectors (e.g. male/female, plug/socket) can include, but are not limited to, USB-A, USB-B, Micro USB, Mini USB, HDMI and variants thereof, and SUB-D.

In some embodiments, electrical connection 1480, 2280 has one or more of the following properties. Electrical connection 1480, 2280 includes a plurality of electrical contacts (e.g. contact pins), preferably at least 4 electrical contact, more preferably at least 8 electrical contacts. The electrical contacts are suitable for signal transmission using low voltages (e.g. safety extra-low voltage, SELV). The electrical contacts have low contact resistances and/or low inherent capacitances. Electrical connector 1480 and electrical connector 2280 are designed for a high number of mating cycles (e.g., at least 10000 mating cycles).

FIG. 2 shows fluid conduit 1200 extending through main body 1100 from first end 1210 to second end 1220. Generally, fluid conduit 1200 is configured to allow for smooth fluid flow through fluid conduit 1200. In some embodiments, fluid conduit 1200 is defined as a substantially straight tube or pipe between first end 1210 and second end 1220. The diameter of fluid conduit 1200 is substantially the same along a direction of fluid flow through fluid conduit 1200 (e.g. from first end 1210 to second end 1220, or vice versa). This may reduce or eliminate disruptions in media flowing through fluid conduit 1200.

FIG. 2A shows a partial side view of the PCB 1400 shown in FIG. 2 in accordance with embodiments of the invention. In some embodiments, electrical connector 1480 is coupled to PCB 1400 based on a “hot-melt” process. Preferably, the hot-melt material has a shore hardness A in the range of 60 to 80, according to ASTM D2240. This coupling seals the connection between electrical connector 1480 and PCB 1400 and can entail at least two effects. On one hand, this electrically isolates the connection and allows thermoplastic casting (e.g., epoxy casting) of PCB 1400 and main body 1100 of measuring device 1000 to fixedly position PCB 1400 and all associated components with respect to main body 1100 and/or fluid conduit 1200. On the other hand, this allows electrical connector 1480 to be mechanically mounted to PCB 1400 in a fixed manner, so that upon coupling of measuring device 1000 to control device 2000, an electrical connection 1480, 2280 can be made more easily (e.g., without requiring electrical connectors 1480 and 2280 to be connected in a separate manual step).

FIG. 3 shows a perspective view of a control device 2000 for measuring fluid flow in accordance with embodiments of this specification. Control device 2000 includes a housing 2100 and a coupling portion 2300. Coupling portion 2300 includes mounting surface 2310 and mounting means 2320. Mounting means 2320 are configure to engage with corresponding mounting means 1320 of measuring device 1000 when measuring device 1000 is coupled to control device 2000.

In some embodiments coupling portion 2300 includes a Bayonet-type lock that can be operated by a switch 2360 (e.g. a slider, pusher, or other handle) respectively locking or unlocking measuring device 1000 in place when measuring device 1000 is coupled to control device 2000. Switch 2360 can be operated from an unlocked position, in which a measuring device 1000 can be mounted to control device 2000 or removed from control device 2000, to a locked position, in which a measuring device 1000 is locked in position and cannot be removed from control device 2000 (or mounted thereto), and vice versa. In some embodiment, switch 2360 can be configured to automatically engage from an unlocked position into a locked position upon insertion of a measuring device 1000 into coupling portion 2300 of device 2000, or upon engagement of measuring device 1000 with mounting surface 2310 of device 2000. The automatic lock can be implemented in the form of a spring-loaded mechanism, in which a spring is biased upon (manual) unlocking of switch 2360 and released upon insertion/engagement of measuring device 1000.

In some embodiments, switch 2360 and/or coupling portion 2300 are configured to provide haptic and/or acoustic feedback. For example, switch 2360 and/or coupling portion 2300 are configured to provide a noticeable click (e.g., haptic/tactile, acoustic; to be perceived by an operator of measuring device 1000) when switch 2360 is placed in a first end position (e.g. a coupling position or an unlocked position) enabling the coupling of measuring device 1000 to control device 2000. Further, switch 2360 and/or coupling portion 2300 are configured to provide a noticeable click (e.g., haptic/tactile, acoustic; to be perceived by an operator of measuring device 1000) when switch 2360 is placed in a second end position (e.g. a locked position) when measuring device 1000 has been successfully coupled to control device 2000 and locked into position.

In the embodiment shown in FIG. 3, mounting means 2320 include circumferentially arranged radial recesses configured to receive corresponding radially protruding projections of mounting means 1320 of measuring device 1000. In some embodiments, the recesses of mounting means 2320 are provided along an inner circumference of coupling portion 2300. Distances between adjacent recesses may be configured to restrict insertion and/or mounting of measuring device 1000 solely in a single position and/or orientation with respect to mounting means 2320 of control device 2000, in order to prevent incorrect or improper mounting of measuring device 1000.

In some embodiments, control device 2000 is at least in part comprised of stainless steel components. This can improve robustness and reliability of control device 2000 over extended periods. This can further improve cleaning and/or maintenance of control device 2000, e.g. when control device 2000 is cleaned, prepped, and/or maintained between periods of operation and/or when one measuring device 1000 is replaced by another measuring device 1000. For example, substantial portions of coupling portion 2300, in particular mounting surface 2310, switch 2360, cover 2380, and/or mounting means 2320 can be at least in part comprised of stainless steel or stainless steel components.

Control device 2000 further includes an electronic control unit (ECU) 2200 (not shown in FIG. 3) configured to be connected to a measuring device 1000, or to components of measuring device 1000, when measuring device 1000 is coupled to control device 2000. Control device 2000 and/or ECU 2200 is configured to control measuring device 1000, when measuring device 1000 is coupled to control device 2000. For example, control device 2000 and/or ECU 2200 is configured to send one or more control signals to measuring device 1000 and/or to receive one or more measurement signals from measuring device 1000, when measuring device 1000 is coupled to control device 2000.

Control device 2000 and/or ECU 2200 further comprises electrical connector 2280 configured to establish electrical connection 1480, 2280 when measuring device 1000 is coupled to control device 2000. Electrical connector 2280 is coupled to control device 2000 and/or ECU 2200 in a float-mounted manner which allows electrical connector 1480 (mounted to PCB 1400 of a measuring device 1000 coupled to control device 2000) to be received so that upon coupling of measuring device 1000 to control device 2000, an electrical connection 1480, 2280 can be made more easily (e.g., when electrical connectors 1480 and 2280 are not fully aligned and/or aligned with high precision).

Control device 2000 and/or ECU 2200 is provided with one or more interfaces configured for data communication with one or more other components (e.g. networked computers, other control units, data storage devices). The one or more interfaces can include one or more of the following: Power over Ethernet (PoE), Controller Area Network (CAN) Bus, Inter-IC (I²C) Bus, UART, Serial Peripheral Interface (SPI), Analog 4-20 mA. Control device 2000 and/or ECU 2200 can be provided with one or more further components, including, but not limited to, electrically Erasable Programmable Read-Only Memory (EEPROM), additional sensors e.g. temperature, pressure, and electrical conductivity, and components configure to control or otherwise communicate with additional sensors (e.g. configured to send control signals to and receive measurement signals from additional sensors).

In some embodiments, control device 2000 includes a status indicator 2210 connected to ECU 2200 and configured to indicate an operating status of control device 2000 and/or an operating status of a measuring device 1000 when measuring device 1000 is coupled to control device 2000. In some embodiments, status indicator 2210 includes a light emitting diode (LED) or similar illuminant configured to emit light of different wavelengths and/or one or more light pulses indicative of an operating status of control device 2000 and/or an operating status of a measuring device 1000 when measuring device 1000 is coupled to control device 2000. In some embodiments, an operating status indicated by status indicator 2210 includes one or more of the following: an operating condition or error condition of ECU 2200 (e.g. booting the system, system error), an operating condition or error condition of measuring device 1000 and/or control device 2000 (e.g. ready for operation, measuring device 1000 coupled to control device 2000, presence of medium to be measured in fluid conduit 1200).

Control device 2000 can further include a cover 2330 (e.g. a flap, lid) configured to cover at least part of coupling portion 2300 and/or mounting surface 2310. In particular, cover 2330 can be configured to cover electrical connector 2280 of control device 2000, when not in use (e.g. when no measuring device 1000 is coupled to control device 2000). In some embodiments, cover 2330 can include a seal 2380 configured to seal electrical connector 2280 when cover 2330 is configured to cover at least part of coupling portion 2300 and/or mounting surface 2310. The seal can be configured to fulfill a particular ingress protection (IP) code, e.g. IPX5, as defined by the International Electrotechnical Commission (IEC) under the international standard IEC 60529 or as defined by the European Union by the European Committee for Electrotechnical Standardization (CENELEC) under EN 60529. Cover 2330 can protect electrical connector 2280 and/or at least part of coupling portion 2300 and/or mounting surface 2310 from, e.g., contamination, fluids, splash water, dust, or particles. In particular, cover 2330 can protect electrical connector 2280 and/or at least part of coupling portion 2300 and/or mounting surface 2310 during a cleaning process of control device 2000. In some embodiments, cover 2330 is implemented as a flap- or lid-type cover that is pivotably mounted to housing 2100 or coupling portion 2300 of control device 2000. In other embodiments, cover 2330 can be implemented as a removable cover, e.g., in the form of a simple releasably attachable cover plate or in the form of a “dummy device” (e.g. having a main body without a fluid conduit 1200 and/or first and second ends 1210, 1220 thereof) that is coupled to control device 2000 in the same or a similar manner as measuring device 1000 is coupled to control device 2000. FIG. 3 shows device 2000 with cover 2330 in an open position in which a measuring device 1000 can be coupled to control device 2000.

FIG. 3A shows a perspective view of a system 100 for measuring fluid flow in accordance with embodiments of this specification. System 100 comprises a control device 2000 and a measuring device 1000. In the embodiment shown in FIG. 3A control device 2000 has a cover 2330 and is shown in an orientation in which the cover is pivotably attached at a bottom side of control device 2000. In other embodiments, cover 2330 can be attached at a top side of control device 2000. In the configuration shown in FIG. 3A, measuring device 1000 is coupled to control device 2000. In some embodiments, when measuring device 1000 is coupled to control device 2000, cover 2330 can assume an engaged position relative to measuring device 1000. In the engaged position, cover 2330 is engaged with measuring device 1000 so that cover 2330 is held in place. During operation, fluid lines (not shown in FIG. 3A) would be connected to measuring device 1000 of system 100.

FIG. 4A shows a perspective view of the control device 2000 for measuring fluid flow in accordance with embodiments of this specification. FIG. 4A shows control device 2000 as described above with respect to FIG. 3. As shown in FIG. 4A, cover 2330 is in a closed position in which cover 2330 covers (e.g., shields, protects, seals) part of coupling portion 2300 and/or mounting surface 2310 of control device 2000, in particular electrical connector 2280 of control device 2000, when no device 1000 is coupled to control device 2000.

FIG. 4B shows a perspective view of a control device 2000 for measuring fluid flow in accordance with embodiments of this specification. In some embodiments, control device 2000 includes a display device 2150 configured to provide a user interface 2155. Display device 2150 is configured to display information to an operator of control device 2000, measuring device 1000, or system 100. In some embodiments, user interface 2155 is configured to perform one or more of the following functions: displaying a current status of control device 2000, measuring device 1000, or system 100, receiving input configured to set, modify, and/or adjust operating parameters of control device 2000, measuring device 1000, or system 100, displaying measurement data of control device 2000, measuring device 1000, or system 100 (e.g., in form of individual data sets, one or more time series of data sets, and/or in real-time).

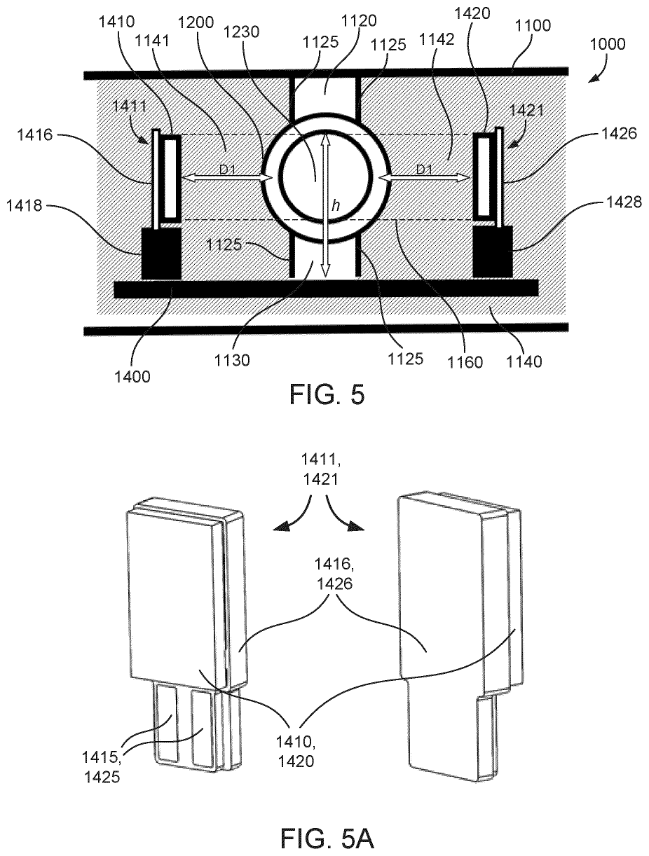

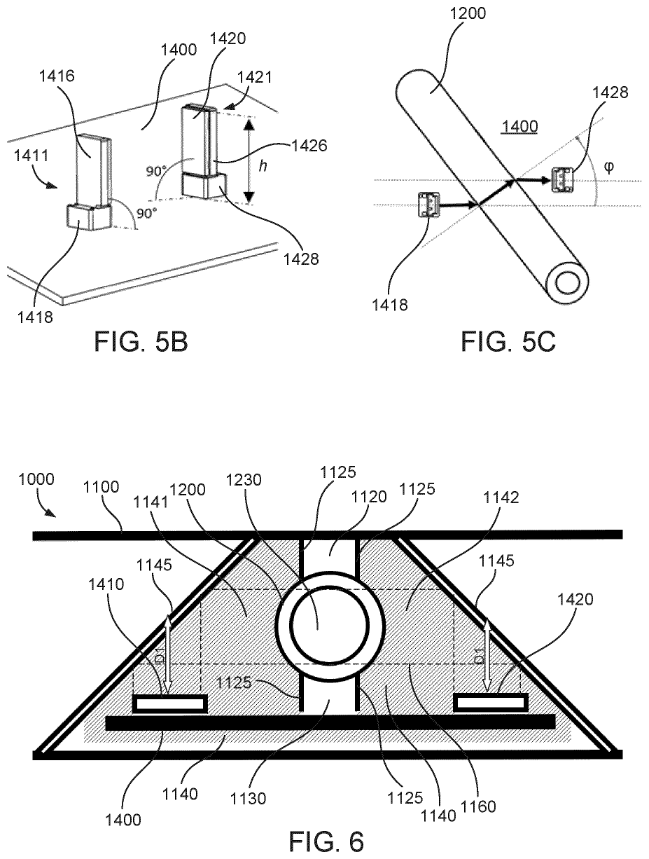

FIG. 5 shows a cross-section view of a measuring device 1000 for measuring fluid flow in accordance with a first embodiment of this specification. Device 1000 according to the first embodiment includes PCB 1400, a first ultrasound transducer 1410, and a second ultrasound transducer 1420. In this specification, an ultrasound transducers may also be referred to as “ceramic” or “piezoelectric ceramic”. The first ultrasound transducer 1410 and the second ultrasound transducer 1420 are respectively connected to a first PCB 1416 and a second PCB 1426. The configuration of ultrasound transducers 1410, 1420 with PCBs 1416, 1426 is described in further detail below. First ultrasound transducer 1410 and first PCB 1416 form a first transducer module 1411. Second ultrasound transducer 1420 and second PCB 1428 form a second transducer module 1421.

Each of first ultrasound transducer 1410 and second ultrasound transducer 1420 can include or consist of piezoelectric ceramic material. Generally, first ultrasound transducer 1410 and second ultrasound transducer 1420 are electrical/acoustic transducers. Preferably, first ultrasound transducer 1410 and second ultrasound transducer 1420 have electrically conductive contact surfaces. In some embodiments, first ultrasound transducer 1410 and second ultrasound transducer 1420 comprise lead zirconate-lead titanate ceramics. In other embodiments, however, first ultrasound transducer 1410 and second ultrasound transducer 1420 can be made of or otherwise comprise other (ceramic) materials.

PCB 1400 includes a first connector 1418 and a second connector 1428. First connector 1418 is configured to receive first transducer module 1411 and to define a position and orientation of first transducer module 1411 relative to PCB 1400. Second connector 1418 is configured to receive second transducer module 1421 and to define a position and orientation of second transducer module 1421 relative to PCB 1400. First connector 1418 and second connector 1428 respectively position and orientate first and second transducer modules 1411 and 1421 substantially perpendicularly to PCB 1400. Further, first and second transducer modules 1411 and 1421 are generally positioned facing each other. In some embodiments, and depending on the configuration of fluid conduit 1200 and on the properties of a medium to be measured, first and second transducer modules 1411 and 1421 are positioned generally facing each other at an offset.

An acoustic coupling medium 1140 (e.g. thermoplastic material, in particular epoxy resin) fills the space around first and second ultrasound transducers 1410, 1420 and between each respective ultrasound transducer 1410, 1420 and fluid conduit 1200. In the embodiment shown in FIG. 5, acoustic coupling medium 1140 has a first portion 1141 and a second portion 1142. In some embodiments, first and second portions 1141, 1142 are connected to one another, e.g. on a side of PCB 1400 opposite to that of first and second ultrasound transducers 1410, 1420. Acoustic coupling medium 1140 includes a sound path 1160 (indicated by dashed lines) extending between the first and second ultrasound transducers 1410, 1420 and through measurement section 1230 of fluid conduit 1200. As described further in this specification, an internal diameter of measurement section 1230 and/or fluid conduit 1200 substantially corresponds to a height of first and second ultrasound transducers 1410, 1420. In the embodiment shown in FIG. 5, sound path 1160 extends from first ultrasound transducer 1410, through first portion 1141, measurement section 1230, second portion 1142, and to second ultrasound transducer 1420.

PCB 1400 is positioned relative to main body 1100 of measuring device 1000 such that first and second transducer modules 1411 and 1421 are positioned on respective opposite sides of fluid conduit 1200. Further, first and second ultrasound transducers 1410 and 1420 are respectively positioned relative to fluid conduit 1200 at a minimum distance D1 as shown in FIG. 5 and such that a top of the respective ultrasound transducer 1410, 1420 is located at the same level as a maximum distance h of an internal diameter of fluid conduit 1200 from the surface of PCB 1400 as shown in FIG. 5. Additionally, a height of the first and second ultrasound transducers 1410, 1420 is selected such that it corresponds to the internal diameter of fluid conduit 1200. The distance between a respective ultrasound transducer 1410, 1420 and fluid conduit 1200 can be crucial for the precision of fluid flow measurements.

Generally, ultrasound transducers 1410, 1420 can generate an ultrasound signal, e.g. an ultrasonic wave. As the ultrasonic wave propagates through a medium one can refer to portions of the ultrasonic wave as a near field and a far field. In the near field, the ultrasonic wave has properties corresponding to a spot emitter, which sends the ultrasonic wave into all directions. When the ultrasonic wave has traveled a certain distance, in the far field, the ultrasonic wave starts to have properties of a unique wave front.

The far field is defined as follows:

$${r}_{far field min} > \frac{{A}_{Ceramic} * {f}_{Transmit}}{π * {c}_{Sound channel}} \qquad ( 1 )$$

with
r_{far field min}→minimum distance to the far field
A_{Ceramic}→effective transmission area
C_{Sound channel}→Speed of sound in the sound channel
fₜᵣₐₙₛₘᵢₜ→Input frequency of the ceramic

The ultrasonic properties of the acoustic coupling medium 1140 (e.g. epoxy resin including sound path 1160) and the input frequency have to be taken into account. The preferred minimum distance D1 between an ultrasound transducer 1410, 1420 and fluid conduit 1200 has been found to be at least 50% of r_{far field min}:

$${r}_{ceramic / reflection surface} > \frac{1}{2} {r}_{far field min} = \frac{1}{2} \frac{{A}_{ceramic} * {f}_{transmit}}{π * {c}_{sound channel}} \qquad ( 2 )$$

with
   r_{ceramic/fluid conduit}→mean minimum distance between ceramic and fluid conduit
   A_{ceramic}→effective emitting area of height and width of the ceramic surface
   C_{sound channel}→speed of sound in the sound channel
   fₜᵣₐₙₛₘᵢₜ→input frequency of the ceramic

In the first embodiment, for example, a minimum distance D1 can be determined, for ultrasound transducers having an effective emitting area A_{ceramic} of 3 mm×6 mm, a sound of speed of 2900 m/s, and an input frequency fₜᵣₐₙₛₘᵢₜ of 4.8 MHz, as follows:

$${r}_{Ceramic / fluid conduit} = \frac{1}{2} \frac{{A}_{Ceramic} * {f}_{Transmit}}{π * {c}_{Sound channel}} = \frac{( 3 mm * 6 mm ) * 4.8 MHz}{π * 2900 m / s} = 0.0 \; 0474 m$$

In an operating configuration of a measuring device 1000 and a control device 2000, ECU 2200 sends a first control signal to first ultrasound transducer 1410. First ultrasound transducer 1410 is configured to emit an ultrasound signal when receiving the first control signal from ECU 2200. The first control signal is sent through electrical connectors 2280 and 1480. First ultrasound transducer 1410 directs the emitted ultrasound signal through acoustic coupling medium 1140 substantially along sound path 1160 towards measurement section 1230 of fluid conduit 1200 and further towards second ultrasound transducer 1420. Acoustic coupling medium 1140 is configured to include substantially homogeneous thermoplastic material (e.g. epoxy resin) free from impurities, such as air bubbles or particles. Acoustic coupling medium 1140 is configured to conduct ultrasound signals from and to first and second ultrasound transducers 1410, 1420 and media present in or flowing through fluid conduit 1200.

Second ultrasound transducer 1420 receives the ultrasound signal emitted by first ultrasound transducer 1410 and generates a measurement signal based on the received ultrasound signal when the emitted ultrasound signal strikes a medium to be measured in measurement section 1230. Generally, and this applies for example to the embodiment shown in FIG. 5 and to the embodiment shown in FIG. 6, the emitted ultrasound signal is substantially directed along sound path 1160 and, thus, substantially exclusively through measurement section 1230 of fluid conduit 1200. This is achieved, in part, by the emitting ultrasound transducer (e.g. ultrasound transducer 1410) being configured to direct the ultrasound signal in a direction of measurement section 1230 (e.g., either directly, see FIG. 5, or indirectly, see FIG. 6). This is further achieved by air backings 1120, 1130 defined by fluid conduit 1200 and/or main body 1100. Air backings 1120, 1130 include air and are configured to reflect, attenuate, or eliminate (at the boundary layer between air backing wall 1125 and air included in air backing 1120, 1130) ultrasound signals entering either one of air backings 1120, 1130. Air backing walls 1125 divide air backings 1120, 1130 from acoustic coupling medium 1140. Air backings 1120, 1130 are configured to attenuate or entirely block ultrasound signals between first and second ultrasound transducers 1410, 1420, that do not travel along sound channel 1160. This can improve measuring resolution and/or precision of measuring device 1000.

Air backing 1130, and associated air backing walls 1125, are further configured to precisely position PCB 1400 relative to fluid conduit 1200. More precise positioning of PCB 1400 relative to fluid conduit 1200 results in more precise positioning of first and second ultrasound transducers 1410, 1420 relative to fluid conduit 1200. This can improve measuring resolution and/or precision of measuring device 1000.

Sound path 1160 illustrates the path of ultrasound signals, e.g. emitted by first ultrasound transducer 1410 and received by second ultrasound transducer 1420, in the direction of and through measurement section 1230. As shown, first and second ultrasound transducers 1410, 1420 are configured to have a height substantially corresponding to a height of fluid conduit 1200. In particular, first and second ultrasound transducers 1410, 1420 are configured to have a height substantially corresponding to an internal diameter of fluid conduit 1200. Further, first and second ultrasound transducers 1410, 1420 are configured to have a width so that an aspect ratio of height to width of the transducer is 3:2 or larger. By modifying the width of first and second ultrasound transducers 1410, 1420 a sensitivity of fluid flow measurements can be adjusted.

By substantially directing the emitted ultrasound signal as described above and substantially exclusively through measurement section 1230 of fluid conduit 1200 can improve the resolution and/or precision of fluid flow measurements.

FIG. 5A shows perspective front and back views of transducer modules 1411, 1421 in accordance with embodiments of this specification. On the left of FIG. 5A, a transducer module (e.g. 1411, 1421) is shown in a perspective front view. On the right of FIG. 5A, a transducer module (e.g. 1411, 1421) is shown in a perspective back view. The transducer module includes the ultrasound transducer (e.g. 1410, 1420), a transducer PCB (e.g. 1416, 1426), and a pair of contacts (e.g. 1415, 1425). The pair of contacts is configured to electrically connect the transducer module to a corresponding connector (e.g. 1418, 1428) of PCB 1400. Each respective contact of the pair of contacts is further configured to electrically connect to a respective electrode of the respective ultrasound transducer to achieve an electrical connection between the respective electrode and a conductive path on PCB 1400.

FIG. 5B shows a perspective view of transducer modules 1411, 1421 positioned on a PCB 1400 in accordance with embodiments of this specification. First connector 1418 is configured to receive first transducer module 1411 and to define a position and orientation of first transducer module 1411 relative to PCB 1400. Second connector 1418 is configured to receive second transducer module 1421 and to define a position and orientation of second transducer module 1421 relative to PCB 1400. First connector 1418 and second connector 1428 respectively position and orientate first and second transducer modules 1411 and 1421 substantially perpendicularly to PCB 1400 (e.g. at a 900 angle relative to a plane of PCB 1400). Further, first and second connectors 1418, 1428 respectively position first and second ultrasound transducers vertically relative to a plane of PCB 1400, such that the top of the respective first and second ultrasound transducers 1410, 1420 is at a same distance h from the surface of PCB 1400. The distance h is configured to correspond to the maximum distance h of an internal diameter of fluid conduit 1200 from the surface of PCB 1400 as shown in FIG. 5.

FIG. 5C shows a top view of connectors 1418, 1428 positioned on a PCB 1400 and configured to receive transducer modules 1411, 1421 in accordance with embodiments of this specification. First and second transducer modules 1411 and 1421 are generally positioned facing each other. In some embodiments, and depending on the properties of a medium to be measured, first and second transducer modules 1411 and 1421 are positioned generally facing each other at an offset determined based on, e.g., Snell-Descartes law.

FIG. 6 shows a cross-section view of a measuring device 1000 for measuring fluid flow in accordance with a second embodiment of this specification. Device 1000 according to the second embodiment includes PCB 1400, a first ultrasound transducer 1410, and a second ultrasound transducer 1420. First ultrasound transducer 1410 and second ultrasound transducer 1420 are directly connected to PCB 1400.

Each of first ultrasound transducer 1410 and second ultrasound transducer 1420 can include or consist of piezoelectric ceramic material as described above with respect to the first embodiment.

PCB 1400 defines a position of first ultrasound transducer 1410 and second ultrasound transducer 1420 relative to acoustic coupling medium 1140, reflection surfaces 1145, and fluid conduit 1200. Further, first and second ultrasound transducers 1410 and 1420 are generally positioned facing a respective reflection surface 1145 and, taking into account the reflection, fluid conduit 1200. Generally, the reflection is defined by a boundary layer at reflection surface 1145 and an air backing on the side of reflection surface 1145 opposite to acoustic coupling medium 1140 and first or second ultrasound transducer 1410, 1420. As described above with respect to air backings 1120, 1130, air at or behind reflection surface 1145 reflects (at the boundary layer between air and reflection surface 1145) ultrasound signals emitted by first or second ultrasound transducer 1410, 1420, so that substantially the entire ultrasound signal is reflected in the direction of and through measurement section 1230.

An acoustic coupling medium 1140 fills the space around first and second ultrasound transducers 1410, 1420 and between each respective ultrasound transducer 1410, 1420 and fluid conduit 1200. In the embodiment shown in FIG. 6, acoustic coupling medium 1140 has a first portion 1141 and a second portion 1142. In some embodiments, first and second portions 1141, 1142 are connected to one another, e.g. on a side of PCB 1400 opposite to that of first and second ultrasound transducers 1410, 1420. Acoustic coupling medium 1140 includes a sound path 1160 (indicated by dashed lines) extending between the first and second ultrasound transducers 1410, 1420 and through measurement section 1230 of fluid conduit 1200. As described further in this specification, an internal diameter of measurement section 1230 and/or fluid conduit 1200 substantially corresponds to a height of first and second ultrasound transducers 1410, 1420 (with the height of height of first and second ultrasound transducers 1410, 1420 being measured along a plane parallel to a surface of PCB 1400 on which first and second ultrasound transducers 1410, 1420 are mounted). In the embodiment shown in FIG. 6, sound path 1160 extends from first ultrasound transducer 1410, through first portion 1141, to reflection surface 1145, further through first portion 1141, measurement section 1230, and second portion 1142, to reflection surface 1145, further through second portion 1142 and to second ultrasound transducer 1420. In the embodiment shown in FIG. 6, reflection surfaces 1145 reflect sound path 1160 two times at an angle of substantially 90°. Reflection surfaces 1145 are, respectively, configured at an angle of substantially 45° with respect to a plane of PCB 1400 and/or a plane in which first and second ultrasound transducers 1410, 1420 are mounted to PCB 1400.

In some embodiments, and depending on the properties of a medium to be measured, first and second ultrasound transducers 1410 and 1420 are positioned generally facing each other at an offset determined based on, e.g., Snell-Descartes law.

PCB 1400 is positioned relative to main body 1100 of measuring device 1000 such that first and second ultrasound transducers 1410 and 1420 are positioned on respective opposite sides of fluid conduit 1200. Further, first and second ultrasound transducers 1410 and 1420 are respectively positioned relative to a respective reflection surface 1145 at a minimum distance D1 as shown in FIG. 6. The distance between a respective ultrasound transducer 1410, 1420 and a respective reflection surface can be crucial for the precision of fluid flow measurements. Generally, the same principles of ultrasonic wave propagation apply to the second embodiment that have been described above with respect to the first embodiment.

For the second embodiment, equation (2) is adapted in that distance D1 defines the distance between a respective ultrasound transducer and a respective reflection surface:

$${r}_{ceramic / reflection surface} > \frac{1}{2} {r}_{far field min} = \frac{1}{2} \frac{{A}_{ceramic} * {f}_{transmit}}{π * {c}_{sound channel}} \qquad ( 2 )$$

with
r_{ceramic/fluid conduit}→mean minimum distance between ceramic and reflection surf ace
A_{ceramic}→effective emitting area of height and width of the ceramic surface
C_{sound channel}→speed of sound in the sound channel
fₜᵣₐₙₛₘᵢₜ→input frequency of the ceramic

In the first embodiment, for example, a minimum distance D1 can be determined, for ultrasound transducers having an effective emitting area A_{ceramic} of 3 mm×6 mm, a sound of speed of 2900 m/s and an input frequency fₜᵣₐₙₛₘᵢₜ of 4.8 MHz, as follows:

$${r}_{Ceramic / fluid conduit} = \frac{1}{2} \frac{{A}_{Ceramic} * {f}_{Transmit}}{π * {c}_{Sound channel}} = \frac{( 3 mm * 6 mm ) * 4.8 MHz}{π * 2900 m / s} = 0.0 \; 0474 m$$

In an operating configuration of a measuring device 1000 and a control device 2000, ECU 2200 sends a first control signal to first ultrasound transducer 1410. First ultrasound transducer 1410 is configured to emit an ultrasound signal when receiving the first control signal from ECU 2200. The first control signal is sent through electrical connectors 2280 and 1480. First ultrasound transducer 1410 directs the emitted ultrasound signal through acoustic coupling medium 1140 substantially along sound path 1160 towards measurement section 1230 of fluid conduit 1200 and further towards second ultrasound transducer 1420.

Second ultrasound transducer 1420 receives the ultrasound signal emitted by first ultrasound transducer 1410 and generates a measurement signal based on the received ultrasound signal when the emitted ultrasound signal strikes a medium to be measured in measurement section 1230. Similar to what is described above with respect to FIG. 5, the emitted ultrasound signal is substantially directed along sound path 1160 and, thus, substantially exclusively through measurement section 1230 of fluid conduit 1200. In the embodiment shown in FIG. 6, the ultrasound signal is reflected twice at respective boundary layers formed at reflection surfaces 1145, which respectively form an angle of about 450 with respect to a plane in which ultrasound transducers are positioned (e.g. substantially parallel to a plane of PCB 1400 as shown in FIG. 6).

This is achieved, in part, by the emitting ultrasound transducer (e.g. ultrasound transducer 1410) being configured to direct the ultrasound signal at a first reflection surface 1145 and, based on the reflection, further in a direction of measurement section 1230. The ultrasound signal is further directed at second reflection surface 1145 and, based on the second reflection, further in a direction of second ultrasound transducer 1420, which is configured to receive the ultrasound signal and to generate a measurement signal based on the received ultrasound signal. Measuring of the fluid flow through fluid conduit 1200 is based on differences in the properties of the emitted ultrasound signal and the received ultrasound signal, which are caused by the characteristics of the media present in or flowing through fluid conduit 1200.

Sound path 1160 as shown in FIG. 6 illustrates the path of ultrasound signals, e.g. emitted by first ultrasound transducer 1410 and received by second ultrasound transducer 1420, in the direction of first reflection surface 1145, through measurement section 1230, in the direction of second reflection surface 1145, and further in the direction of second ultrasound transducer 1420. As shown, first and second ultrasound transducers 1410, 1420 are configured to have a height substantially corresponding to a height of fluid conduit 1200. In particular, first and second ultrasound transducers 1410, 1420 are configured to have a height substantially corresponding to an internal diameter of fluid conduit 1200. Further, first and second ultrasound transducers 1410, 1420 are configured to have a width so that an aspect ratio of height to width of the transducer is 3:2 or larger. By modifying the width of first and second ultrasound transducers 1410, 1420 a sensitivity of fluid flow measurements can be adjusted.

By substantially directing the emitted ultrasound signal as described above and substantially exclusively through measurement section 1230 of fluid conduit 1200 can improve the resolution and/or precision of fluid flow measurements.

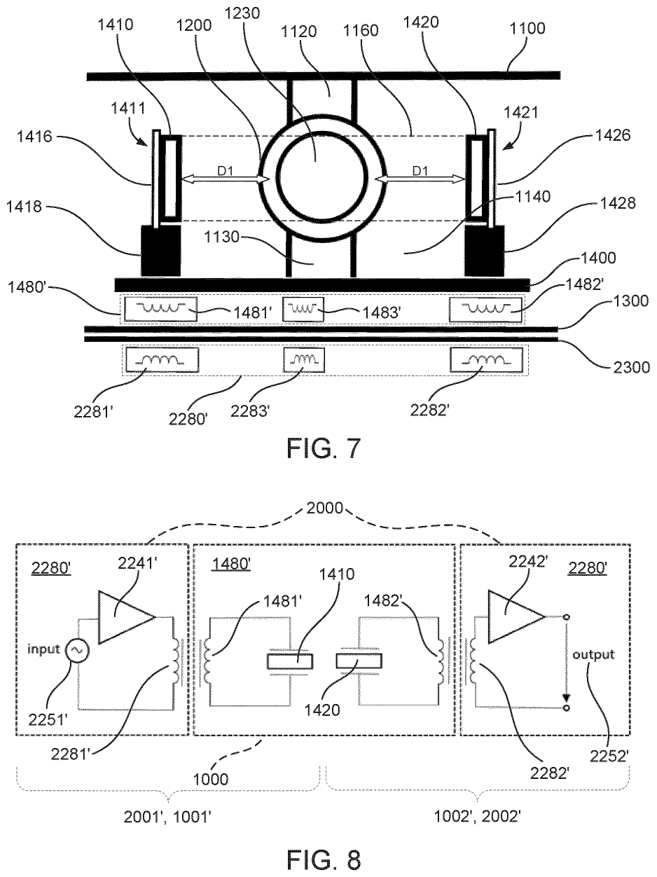

FIG. 7 shows a cross-section view of a measuring device 1000 and a control device 2000 for measuring fluid flow in accordance with the first embodiment of this specification illustrating a second variant of the electrical connection 1480′, 2280′. As described in this specification, according to the first variant of electrical connection 1480, 2280, electrical connector 1480 and electrical connector 2280 are mechanically connected to realize electrical connection 1480, 2280, when measuring device 1000 is coupled to control device 2000. According to the second variant of the electrical connection, an inductive electrical connection 1480′, 2280′ is made based on an inductive connection between the ultrasound transducers (e.g. transducers 1410, 1420 or modules 1411, 1421) of measuring device 1000 and control device 2000 (e.g., ECU 2200). This can reduce or prevent issues (e.g., mechanical, electrical, wear, and/or tear) with the connection of electrical connectors 1480, 2280 (e.g. plug and socket, male and female connectors).

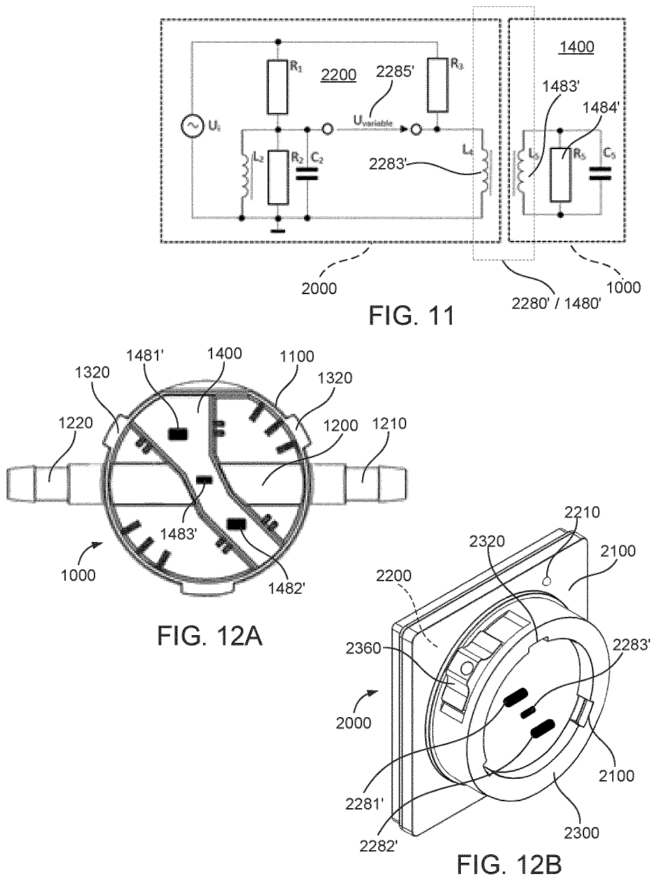

Inductive electrical connection 1480′, 2280′ can be established using electrical connector 1480′ of measuring device 1000 and electrical connector 2280′ of control device 2000, e.g. as shown in FIG. 7. Electrical connector 1480′ of measuring device 1000 includes a first coil 1481′ and a second coil 1482′, and, optionally, a third coil 1483′. First coil 1481′ and second coil 1482′, and, optionally, third coil 1483′ are connected to PCB 1400 of measuring device 1000. Configurations using respective third coils 1483′ and 2283′ are described below with respect to FIG. 11. Corresponding electrical connections between the components connected to PCB 1400 are realized as conductive paths defined by PCB 1400. Electrical connector 2280′ of control device 2000 includes a first coil 2281′ and a second coil 2282′, and, optionally, a third coil 2283′. First ultrasound transducer 1410 (or module 1411) is electrically connected to first coil 1481′ of measuring device 1000 and second ultrasound transducer 1420 (or module 1421) is electrically connected to second coil 1482′ of measuring device 1000. First coil 2281′ of control device 2000 and second coil 2282′ of control device 2000 are electrically connected to ECU 2200 (not shown in FIG. 7).

First and second ultrasound transducers 1410, 1420 are configured to operate based on sinusoidal AC voltages. For example, an ultrasound transducer (e.g., one of ultrasound transducers 1410, 1420) can be configured transmit an ultrasound signal in response to receiving an (input) control signal (e.g. in the form of a sinusoidal AC voltage). The control signal can be adapted to achieve a desired ultrasound signal emitted from the ultrasound transducer. Further, an ultrasound transducer (e.g., one of ultrasound transducers 1410, 1420 not emitting an ultrasound signal) can be configured to generate an (output) measurement signal (e.g. in the form of a sinusoidal AC voltage) in response to receiving an ultrasound signal (e.g. the ultrasound signal emitted from another ultrasound transducer).

In some embodiments, the inductive connection (e.g., 1480′, 2280′; 1480″, 2280″) is configured to not extend a phase of the transmitted and received (raw) ultrasound signals. Further, the inductive electrical connection shall not exceed an attenuation of 10 dB.

First coil 1481′ of measuring device 1000 is arranged relative to coupling portion 1300 of measuring device 1000 and first coil 2281′ of control device 2000 is arranged relative to coupling portion 2300 of control device 2000 so that the first coils 1481′ and 2281′ are in proximity to one another when measuring device 1000 is coupled to control device 2000. Second coil 1482′ of measuring device 1000 is arranged relative to coupling portion 1300 of measuring device 1000 and second coil 2282′ of control device 2000 is arranged relative to coupling portion 2300 of control device 2000 so that the second coils 1482′ and 2282′ are in proximity to one another when measuring device 1000 is coupled to control device 2000.

In some embodiments, first and second coils 1481′, 2281′, 1482′, 2282′ of measuring device 1000 and control device 2000 have a diameter of 3 to 10 mm, preferably 3 mm, and are arranged at respective distances from one another (e.g., pairwise coils 1481′ and 2281′, and coils 1482′ and 2282′) of 3 to 10 mm, preferably 3 mm.

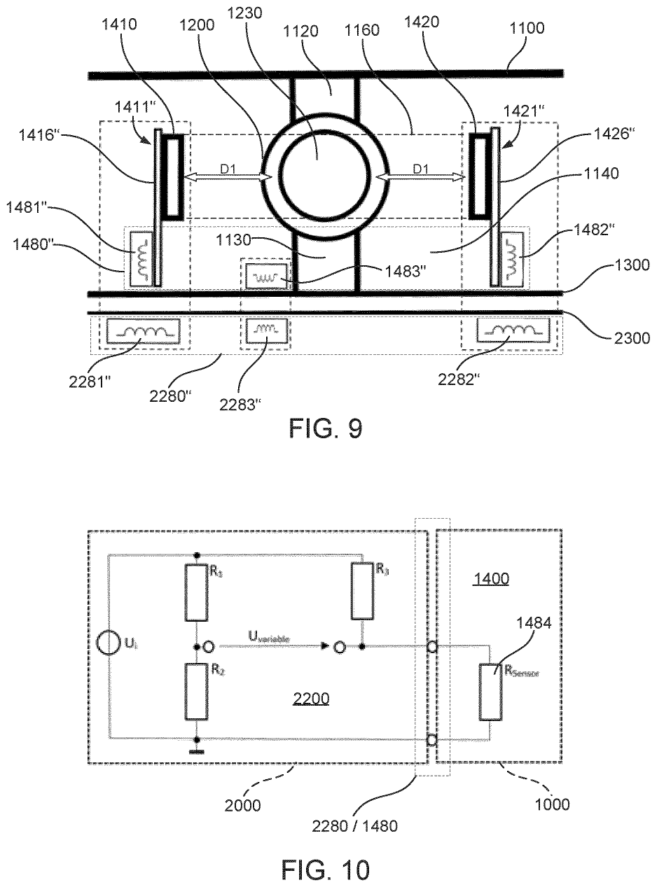

In some embodiments, the distance between the two coils of respectively corresponding pairs of coils (e.g., coils 1481′, 2281′; coils 1482′, 2280′; and, optionally, coils 1483′, 2283′ in FIGS. 7, 8; see also coils 1481″, 2281″; coils 1482″, 2280″; and, optionally, coils 1483″, 2283″ in FIGS. 9, 11) does not exceed a maximum distance of 5 mm. In preferred embodiments, the distance is in a range from 3 to 5 mm; more preferably the distance is less than 3 mm. The number of preferred windings depends, in part, on a desired frequency to be emitted by the emitting ultrasound transducer. Generally, properties of the coils (e.g., conductor material, conductor thickness, number of windings, etc.) can be adapted to individual applications. In some embodiments, the properties of corresponding pairs of coils (e.g., coils 1481′, 2281′; coils 1482′, 2280′; coils 1483′, 2283′; coils 1481″, 2281″; coils 1482″, 2280″; coils 1483″, 2283″) are matched to one another, although the properties of any one pair of coils may be different from the properties of another pair of coils.

FIG. 8 shows an electrical circuit diagram of an electrical connection 1480′, 2280′ for a measuring device 1000 and a control device 2000 for measuring fluid flow in accordance with the first embodiment of this specification. Inductive electrical connection 1480′, 2280′ is established using electrical connector 1480′ of measuring device 1000 and electrical connector 2280′ of control device 2000. Although devices 1000, 2000 are not shown in FIG. 8, it is understood that measuring device 1000 includes electrical connector 1480′ and control device 2000 includes electrical connector 2280′. Generally, as an example configuration, FIG. 8 shows a transmitting circuit 2001′, 1001′ on the left side and a receiving circuit 1002′, 2002′ on the right side of the figure. The example shown in FIG. 8 does not limit the embodiment(s) or variant(s) with respect to alternative configurations (e.g. switching the configurations of the components of respective sides).

Electrical connector 1480′ of measuring device 1000 includes first coil 1481′ and second coil 1482′. The optional third coil 1483′ is not shown in FIG. 8. Electrical connector 2280′ of control device 2000 includes first coil 2281′ and second coil 2282′. The optional third coil 2283′ is not shown in FIG. 8. First ultrasound transducer 1410 (or transducer module 1411) is electrically connected to first coil 1481′ of measuring device 1000 and second ultrasound transducer 1420 (or module 1421) is electrically connected to second coil 1482′ of measuring device 1000. First coil 2281′ of control device 2000 and second coil 2282′ of control device 2000 are electrically connected to ECU 2200 (not shown in FIG. 8). The electrical circuit implemented by ECU 2200 of control device 2000 further includes, for a signal emitting transducer (e.g. ultrasound transducer 1410 or transducer module 1411) an input 2251′ and an amplifier 2241′. Amplifier 2241′ is configured to amplify an input signal transmitted to coil 2281′. The electrical circuit implemented by ECU 2200 of control device 2000 further includes, for a signal generating transducer (e.g. ultrasound transducer 1420 or transducer module 1421) an output 2252′ and an amplifier 2242′. Amplifier 2242′ is configured to amplify an output signal transmitted from coil 2282′.

FIG. 9 shows a cross-section view a measuring device 1000 and a control device 2000 for measuring fluid flow in accordance with the first embodiment of this specification illustrating a third variant of the electrical connection 1480″, 2280″. According to the third variant of the electrical connection, an inductive electrical connection 1480″, 2280″ is made based on an inductive connection between the ultrasound transducers (e.g. transducers 1410, 1420 or modules 1411, 1421) of measuring device 1000 and control device 2000 (e.g., ECU 2200). This can reduce or prevent issues (e.g., mechanical, electrical, wear, and/or tear) with the connection of electrical connectors 1480, 2280 (e.g. plug and socket, male and female connectors).

Inductive electrical connection 1480″, 2280″ is established using electrical connector 1480″ of measuring device 1000 and electrical connector 2280″ of control device 2000, e.g. as shown in FIG. 9. Electrical connector 1480″ of measuring device 1000 includes a first coil 1481″ and a second coil 1482″, and, optionally, a third coil 1483″. First coil 1481″ and second coil 1482″, and, optionally, third coil 1483″ are connected to coupling portion 1300 and/or main body 1100 of measuring device 1000. Configurations using respective third coils 1483″ and 2283″ are described below with respect to FIG. 11.

According to the third variant of electrical connection 1480″, 2280″, no PCB 1400 is required to realize an electrical connection between the components. First coil 1481″ and first ultrasound transducer 1410 are electrically connected to one another by first PCB 1416″, forming first transducer module 1411″ including first ultrasound transducer 1410, first PCB 1416″, and first coil 1481″. Second coil 1482″ and second ultrasound transducer 1420 are electrically connected to one another by second PCB 1426″, forming second transducer module 1421″ including second ultrasound transducer 1420, second PCB 1426″, and second coil 1482″. Corresponding electrical connections between the components connected to first and second PCBs 1416″, 1426″ are respectively realized as conductive paths defined by the respective PCB. Electrical connector 2280″ of control device 2000 includes a first coil 2281″ and a second coil 2282″, and, optionally, a third coil 2283″.

First and second ultrasound transducers 1410, 1420 are configured to operate based on sinusoidal AC voltages as described with respect to FIG. 7 above. Electrical connection 1480″, 2280″ according to the third variant operates in the same manner as described above with respect to the second variant, and, unless specifically stated otherwise, with respect to the first variant.

First coil 1481″ of measuring device 1000 is arranged relative to coupling portion 1300 of measuring device 1000 and first coil 2281″ of control device 2000 is arranged relative to coupling portion 2300 of control device 2000 so that the first coils 1481″ and 2281″ are in proximity to one another when measuring device 1000 is coupled to control device 2000. Second coil 1482″ of measuring device 1000 is arranged relative to coupling portion 1300 of measuring device 1000 and second coil 2282″ of control device 2000 is arranged relative to coupling portion 2300 of control device 2000 so that the second coils 1482″ and 2282″ are in proximity to one another when measuring device 1000 is coupled to control device 2000. In some embodiments, first and second coils 1481″, 2281″, 1482″, 2282″ of measuring device 1000 and control device 2000 have a diameter of 3 to 10 mm, preferably 5 mm, and are arranged at respective distances from one another (e.g., pairwise coils 1481″ and 2281″, and coils 1482″ and 2282″) of 2 to 10 mm, preferably 5 mm.

In some embodiments, measuring device 1000 is provided with an electrical connection (e.g. 1480, 2280; 1480′, 2280′; 1480″, 2280″) in accordance with any one of the first, second, and third variants described in this specification. In some embodiments, control device 2000 is configured to support any one electrical connection (e.g. 1480, 2280; 1480′, 2280′; 1480″, 2280″), or combinations of two or more of the electrical connections (e.g. 1480, 2280; 1480′, 2280′; 1480″, 2280″), in accordance with the first, second, and third variants described in this specification.

FIG. 10 shows an electrical circuit diagram of an electrical circuit for detecting a measuring device 1000 in accordance with embodiments of this specification. Generally, control device 2000 is configured to detect the presence of measuring device 1000 when the latter is coupled to control device 2000. Additionally or alternatively, control device 2000 can be configured to detect a configuration or a type of measuring device 1000 when the latter is coupled to control device 2000. This can be realized based on an electrical circuit, e.g., as shown in FIG. 10 or 11.

FIG. 10 shows an electrical circuit implemented by ECU 2200 of control device 2000 and PCB 1400 of measuring device 1000. The electrical circuit is configured to detect a presence, configuration, and/or type of measuring device using electrical connection 1480, 2280 according to the first variant and based on a resistor 1484 (“Rₛₑₙₛₒᵣ”). The electrical circuit can be configured to implement a resistance detection based on a “Wheatstone Bridge”. In one embodiment, resistors R₁, R₂, R₃ are constant and resistor 1484, Rₛₑₙₛₒᵣ, is variable. Each variant of measuring device 1000, i.e. measuring devices having different properties (e.g., having fluid conduits 1200 of different diameter) can be configured using a respective resistor 1484, Rₛₑₙₛₒᵣ, having a selected or predetermined resistance value. The predetermined resistance can be between 1 and 200 kΩ, and/or can be set so that the generated measuring voltage resulting from the different resistances can be reliably determined. The voltage U_{variable} can be calculated based on the following formula:

$${U}_{variable} = ( \frac{{R}_{2}}{{R}_{1} + {R}_{2}} - \frac{{R}_{Sensor}}{{R}_{Sensor} + {R}_{3}} ) * {U}_{i}$$

Depending on the resistance of resistor 1484, Rₛₑₙₛₒᵣ, a voltage U_{variable} is set. With this circuit a respective variant of measuring device 1000 can be determined. This can allow control device 2000 to adjust operating parameters to the respective measuring device 1000 coupled to control device 2000, by selecting a corresponding configuration and/or setting corresponding operating parameters. The circuit shown in FIG. 10 is configured to operate using DC voltage.

FIG. 11 shows an electrical circuit diagram of an electrical circuit for detecting a measuring device 1000 in accordance with embodiments of this specification. The electrical circuit shown in FIG. 11 is configured to detect a presence, configuration, and/or type of measuring device using an inductive electrical connection according to the second or third variants (1480′, 2280′ or 1480″, 2280″) described in this specification. FIG. 11 illustrates the working principle based on the second variant 1480′, 2280′. However, the circuit can also be implemented using the third variant 1480″, 2280″ of the electrical connection as described in this specification. What is described in the following paragraph with respect to third coils 1483′ and 2283′ is understood to be applicable to first and second coils 1483″ and 2283″ of the third variant of electrical connection 1480″, 2280″ as described in this specification.

The detection is based on a resistor 1484′ (“R₅”). The electrical circuit can also be configured to implement a resistance detection based on a “Wheatstone Bridge” as described above with respect to FIG. 10. Resistors R₂ 2284′ and R₅ 1484′ are, respectively, part of an electrical oscillating circuit. The oscillating circuit on the control device 2000 side with coil L₂, resistor R₂ 2284′ and capacitor C₂ is constant. The oscillating circuit on the measuring device 1000 side (see coil L₅, resistor R₅ 1484′, and capacitor Cs) is variable. The coils L₄ 2283′ and L₅ 1483′ are single coils, but they are arranged, when measuring device 1000 is coupled to control device 2000, in proximity to one another so that they form a transformer. When the connected load changes due to the presence of the oscillating circuit of measuring device 1000 when coupled to control device 2000, the voltage U_{variable} 2285′ also changes. This can be detected by ECU 2200 of control device 2000 and can allow control device 2000 to adjust operating parameters to the respective measuring device 1000 coupled to control device 2000, by selecting a corresponding configuration and/or setting corresponding operating parameters. The circuit shown in FIG. 11 is configured to operate using AC voltage.

FIG. 12A shows a bottom view of the measuring device 1000 for measuring fluid flow in accordance with embodiments of this specification. Measuring device 1000 as shown in FIG. 12A is provided with an inductive electrical connection 1480′, 2280′ (or, alternatively, inductive electrical connection 1480″, 2280″). PCB 1400 includes respective first and second ultrasound transducers 1410, 1420 (not shown in FIG. 12A) and respectively associated coils 1481′, 1482′. In some embodiments, coils 1481′, 1482′ are arranged on a first side of PCB 1400 (e.g. a first side of PCB 1400 facing towards coupling portion 2300 of control device 2000 when measuring device 1000 is coupled to control device 2000) and first and second transducers 1410, 1420 are arranged on a second side of PCB 1400 opposite the first side. As shown in FIG. 12A, coils 1481′ and 1482′ (and, optionally, coil 1483′) are respectively positioned in a spaced-apart manner from one another such that inductive signals do not interfere with adjacent coils and/or pairs of coils (e.g., coils 1481′, 2281′; coils 1482′, 2280′; and, optionally, coils 1483′, 2283′ in FIGS. 7, 8; see also coils 1481″, 2281″; coils 1482″, 2280″; and, optionally, coils 1483″, 2283″ in FIGS. 9, 11).

FIG. 12B shows a perspective view of the control device 2000 for measuring fluid flow in accordance with embodiments of this specification. Control device 2000 as shown in FIG. 12B is provided with an inductive electrical connection 1480′, 2280′ (or, alternatively, inductive electrical connection 1480″, 2280″). Coupling portion 2300 of control device 2000 includes respective coils 2281′, 2282′. In some embodiments, coils 2281′, 2282′ are generally arranged on mounting surface 2310 facing towards coupling portion 1300 of measuring device 1000 when measuring device 1000 is coupled to control device 2000. However, coils 2281′, 2282′ can be arranged in a variety of positions on or within coupling portion 2300 of control device 2000, as long as the respective coils can be placed in proximity to corresponding coils of measuring device 1000. As shown in FIG. 12B, coils 2281′ and 2282′ (and, optionally, coil 2283′) are respectively positioned in a spaced-apart manner from one another such that inductive signals do not interfere with adjacent coils and/or pairs of coils (e.g., coils 1481′, 2281′; coils 1482′, 2280′; and, optionally, coils 1483′, 2283′ in FIGS. 7, 8; see also coils 1481″, 2281″; coils 1482″, 2280″; and, optionally, coils 1483″, 2283″ in FIGS. 9, 11).

In some embodiments, control device 2000 and/or coupling portion 2300 is at least in part comprised of stainless steel components. Such components may prevent or interfere with inductive electrical connections as described in this specification. In such embodiments, when control device 2000 implements any of the inductive electrical connections 2280′ or 2280″, respective portions of coupling portion 2300 and/or mounting surface 2310 made of stainless steel can be configured to include portions that are made of a material that does not prevent or interfere with inductive coupling as described in this specification. In some embodiments, the material can include a thermoplastic material, e.g. epoxy resin.

Some embodiments of system 100 may implement a hybrid configuration of elements from the first, second, and third variants of electrical connections (e.g. 1480, 2280; 1480′, 2280′; 1480″, 2280″). For example, control device 2000 of system 100 can be configured to provide both electrical connection 2280 (e.g. based on male/female or plug/socket type electrical connectors as described in this specification) and inductive electrical connection 2280′ or 2280″ (e.g. based on inductive coupling of respective pairs of coils as described in this specification). Such a “hybrid” control device 2000 is configured to receive measuring devices 1000 that implement either electrical connection 1480 (e.g. based on male/female or plug/socket type electrical connectors as described in this specification) or inductive electrical connection 1480′ or 1480″ (e.g. based on inductive coupling of respective pairs of coils as described in this specification).

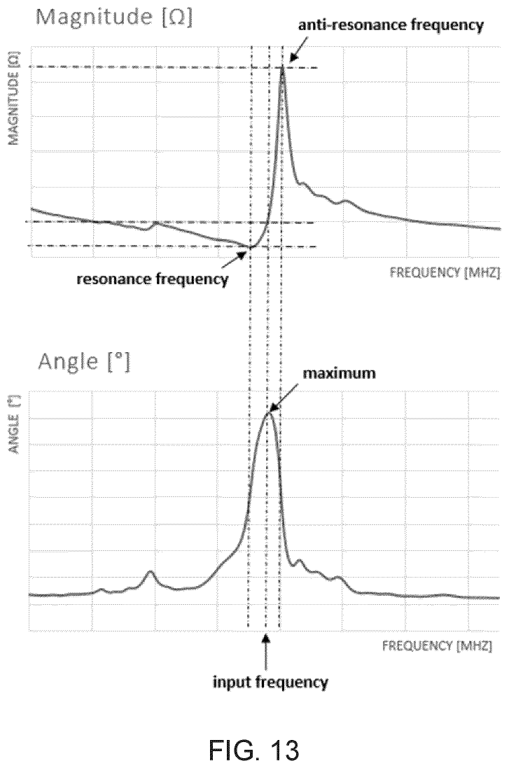

FIG. 13 shows a diagram illustrating a process for determining pairs of ultrasound transducers for use according to embodiments of this specification. First and second ultrasound transducers 1410, 1420 for use, as a pair of transducers, in a measuring device 1000 are selected to have properties that are aligned or matched with one another. This can substantially increase resolution and/or precision of measurements performed with the measuring device 1000. The properties of the transducers (e.g. ceramics) are determined based on the magnitude and the angle (or phase), as shown in the diagram of FIG. 13. Based on the phase diagram, the maximum angle is detected (see bottom diagram of FIG. 13) and the corresponding frequency is determined. The determined frequency (i.e. “input frequency”) denotes the optimum frequency at which the transducer is operated. In the magnitude diagram (see top diagram in FIG. 13), the magnitudes of the transducer are determined at the anti-resonance frequency, the resonance frequency, and the input frequency. For the pairwise selection of transducers, the determined properties are evaluated and the transducers are sorted accordingly. Subsequently, transducers having the same acoustic properties are selected for use in the production of measuring devices 1000.

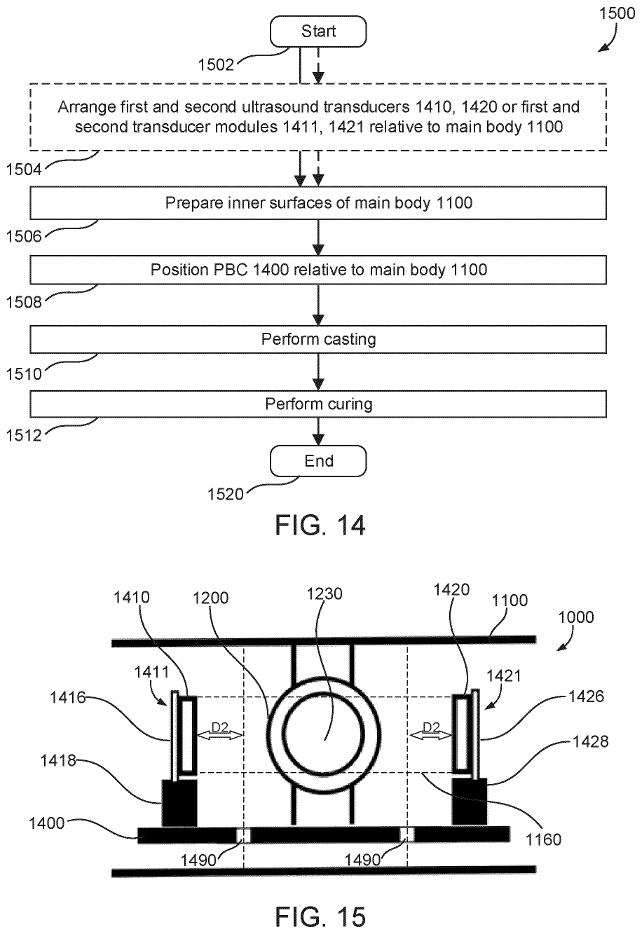

FIG. 14 is a flowchart of an example process 1500 for manufacturing a measuring device 1000 in accordance with embodiments of this specification. Epoxy resin processing is generally a very complex process, as environmental influences can cause material properties to be affected. With respect to process 1500, in particular in terms of casting, several aspects are considered.

In some embodiments, the epoxy resin used for casting includes a two-component epoxy, comprising a resin and a hardener. During mixing of the epoxy resin, a particular mixing ratio has to be observed in accordance with manufacture instructions of the respective material used. Even slight variations in the mixing ratio can result in undesired changes of material properties of the epoxy resin and, thus, in changes to ultrasonic properties of the epoxy resin, which forms acoustic coupling medium 1140. For this reason, the epoxy resin is mixed in a mixing/casting device and under a defined process and process conditions. The surfaces of the objects to be casted must be free of grease and oil. The adhesion of epoxy resin to high temperature plastics such as PPSU, PSU and PES can also be problematic because the surface tension of such materials is typically relatively low. Therefore, it is advisable to activate the surface of the plastics, e.g. using a cold plasma process. The epoxy resin is preferably of low-viscosity in order to be able to cast sound path 1160 free of air bubbles as much as possible. If the epoxy resin were highly viscous, air reservoirs could, and would likely, form in sound path 1160. This could lead to undesired and/or uncontrolled deflection of ultrasound signals. Even with low viscosity epoxy resins, air reservoirs can form in acoustic coupling medium 1140 and/or in sound path 1160. For this reason, it is highly desirable that any enclosed air is able to escape from acoustic coupling medium 1140 and/or from sound path 1160. Constructively, this can be done through openings and/or slots in PCB 1400. Very small air bubbles (e.g., having a diameter of less than 1 mm) can be created especially on metallic surfaces such as ceramics (e.g. ultrasound transducers 1410, 1420). Such air bubbles, like those of the air backings, could lead to undesired and/or uncontrolled deflection of ultrasound signals and, thus, should be avoided as much as possible. After casting, the pressure is increased again to atmosphere. The curing is then carried out at a constant temperature.

Process 1500 starts at step 1502. If process 1500 comprises optional step 1504, the process continues at step 1504, otherwise the process continues at step 1506.

At optional step 1504, first and second ultrasound transducers 1410, 1420 or first and second transducer modules 1411, 1421 are arranged relative to PBC 1400. In step 1504, depending on the embodiment (e.g. one of the first and second embodiments described in this specification) either first and second transducer modules 1411, 1421 are arranged relative to PCB 1400 (e.g., inserted into connectors 1418, 1428; see FIGS. 5, 5B) or first and second ultrasound transducers 1410, 1420 are electrically and mechanically connected to PCB 1400 (e.g. as shown in FIG. 6). Main body 1100 is configured with a different recess forming the casting cavity for acoustic coupling medium 1140 depending on the respective embodiment (e.g., without or with reflection surfaces 1145; see FIGS. 5, 6).

At step 1506, inner surfaces of main body 1100 are prepared by activating the surfaces of the plastics surrounding acoustic coupling medium 1140, e.g. using a cold plasma process. Step 1506 can additionally include examining inner surfaces of main body 1100 defining the casting cavity for acoustic coupling medium 1140 and/or sound path 1160 for contamination such as oils and greases, and/or additional object removal or cleaning steps.

At step 1508, PCB 1400 is positioned relative to main body 1100. Main body 1100 is provided with structural features (e.g. one or more grooves, notches, bars, pins, abutments) that allow for a precise positioning of PCB 1400 and, thus, of ultrasound transducers 1410, 1420, relative to fluid conduit 1200.

At step 1510, casting is performed. In order to reduce the number and/or presence of air bubbles or to prevent their formation entirely, the casting process takes place under vacuum. During curing, the epoxy resin shrinks up to 15%. Therefore, the encapsulation volume covered by acoustic coupling medium 1140 is at least 30% larger than that of sound path 1160 to ensure that the likelihood of the formation of air bubbles or reservoirs in sound path 1160 is reduced or eliminated. In some embodiments, PCB 1400 is provided with one or more openings that allow for epoxy resin to flow into the casting cavity when the epoxy resin shrinks during casting and/or curing. This can reduce or entirely prevent a mechanical deformation of PCB 1400 and/or other components caused by shrinking of the epoxy resin. A mechanical deformation could negatively affect the resolution and/or precision of measurements subsequently performed using measuring device 1000.

At step 1512, curing is performed under controlled conditions, defined by respective profiles for, e.g., temperature and relative humidity. Process 1500 ends at step 1520.

FIG. 15 shows a cross-section view of a measuring device 1000 for measuring fluid flow in accordance with the first embodiment of this specification. In some embodiments, PCB 1400 is provided with openings 1490. When casting and curing of the epoxy resin is performed, as described in the specification, the resin is prone to shrinking. Openings 1490 serve to allow for further influx of resin into the cavity so that substantially the entire cavity can be occupied by the resin (see, e.g., first and second portions 1141 and 1142 of acoustic coupling medium 1140 as shown in FIG. 5). Openings 1490 are located at a distance D2 that is substantially half the distance D1, i.e. it is substantially half of the distance between a respective ultrasound transducer 1410, 1420, and measurement section 1230 of fluid conduit 1200:

$${r}_{ceramic / opening} = \frac{{r}_{ceramic / fluid conduit}}{2}$$

Positioning openings 1490 at the distance D2 (i.e. r_{ceramic/opening}) that is substantially half of the distance between a respective ultrasound transducer 1410, 1420, and measurement section 1230 of fluid conduit 1200 can allow for an even and unrestricted influx of resin during casting and/or curing, so that precise positioning and/or orientation of ultrasound transducers 1410, 1420 is not negatively impacted, e.g. by forces exerted by the shrinking of the epoxy resin during casting and/or curing.

To provide for interaction with a user, the subject matter described in this specification can be implemented on one or more computers (e.g. ECU 2100) having, or configured to communicate with, a display device (e.g. 2150 as shown in FIG. 4B), e.g., a LCD (liquid crystal display) monitor, for displaying information to the user, and an input device by which the user can provide input to the computer, e.g., a touch display 2150 configured to provide a user interface 2155 (see, e.g., FIG. 4B), a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures.

This specification uses the term “configured to” in connection with systems, devices, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A measuring device configured for coupling to a control device (2000), the measuring device comprising:
a fluid conduit;
a first electrical connector;
a first ultrasound transducer and a second ultrasound transducer, each electrically connected to the first electrical connector; and
an acoustic coupling medium coupling the first and second ultrasound transducers to the fluid conduit, wherein
the first ultrasound transducer is configured to emit, in response to receiving a control signal, an ultrasound signal along a sound path extending through the acoustic coupling medium from the first ultrasound transducer to the second ultrasound transducer, and
the second ultrasound transducer is configured to receive an ultrasound signal transmitted along the sound path and to generate a measurement signal based on the received ultrasound signal wherein the fluid conduit is disposed at least in part along the sound path such that the emitted ultrasound signal propagates along the sound path and strikes, in a measurement section of the fluid conduit, a medium to be measured.

2. The measuring device of claim 1, wherein the acoustic coupling medium includes a first portion a second portion, wherein the first portion couples the first ultrasound transducer to the fluid conduit and the second portion couples the second ultrasound transducer to the fluid conduit.

3. The measuring device of claim 2, further comprising air backings positioned adjacent to the fluid conduit and separating the first portion of the acoustic coupling medium and the second portion of the acoustic coupling medium from one another.

4. The measuring device of claim 3, wherein the air backings are configured to acoustically decouple the first portion of the acoustic coupling medium from the second portion of the acoustic coupling medium, such that ultrasounds signals propagating along the sound path do not propagate directly from the first portion into the second portion.

5. The measuring device of claim 2, wherein the sound path extends from the first ultrasound transducer to the second ultrasound transducer through the first portion of the acoustic coupling medium, through measurement section, and through the second portion of the acoustic coupling medium.

6. The measuring device of claim 1, wherein the acoustic coupling medium comprises thermoplastic material that includes epoxy resin or is substantially homogeneous.

7. The measuring device of claim 1, further comprising a printed circuit board, PCB, including the first electrical connector and configured to electrically connect the first and second ultrasound transducers to the first electrical connector.

8. (canceled)

9. The measuring device of claim 7, wherein the first ultrasound transducer and the first connecting portion of the first ultrasound transducer form a first transducer module the second ultrasound transducer and the second connecting portion of the second ultrasound transducer form a second transducer module, and
wherein the first connecting portion (1418) and the second connecting portion (1428) of the PCB (1400) are configure to electrically and mechanically connect the first (1410) and second (1420) ultrasound transducers to the PCB.

10. (canceled)

11. (canceled)

12. (canceled)

13. The measuring device of claim 1, wherein the first electrical connector comprises a first coil and a second coil, and
wherein the first coil is configured to inductively couple to a first coil of a control device and the second coil is configured to inductively couple to a second coil of the control device.

14. (canceled)

15. (canceled)

16. (canceled)

17. (canceled)

18. (canceled)

19. The measuring device of claim 1, wherein the first ultrasound transducer is configured to receive the control signal from a control device through the first electrical connector or wherein the second ultrasound transducer is configured to transmit the measurement signal to the control device through the first electrical connector.

20. The measuring device of claim 1, further comprising one or more sensors, wherein the one or more sensors include one or more of:
a temperature sensor,
a pressure sensor,
an electrical conductivity sensor, and
an optical sensor.

21. The measuring device of claim 1, wherein
an inner diameter of the fluid conduit is in a range of 0.1 to 1.5 inches (0.254 to 3.81 cm).

22. The measuring device of claim 1, wherein the fluid conduit has a first end and a second end in fluid communication with one another and configured to attach to a fluid circuit, and
wherein at least one of the first end or the second end includes one of the following: a sanitary connector, an Aseptic Quick Connector, and an MPX Insert.

23. (canceled)

24. The measuring device of claim 1, further comprising a main body,
wherein the main body includes a coupling portion configured for coupling the measuring device to a control device,
wherein the main body defines the fluid conduit as an integral portion thereof, and
wherein the main body is configured to fixedly position the PCB relative to the fluid conduit.

25. (canceled)

26. (canceled)

27. (canceled)

28. The measuring device of claim 1, wherein the first ultrasound transducer and the second ultrasound transducer are fixedly positioned relative to the fluid conduit by the acoustic coupling medium.

29. (canceled)

30. A control device comprising:
a housing including a coupling portion configured for receiving a measuring device;
a second electrical connector;
an electronic control unit, ECU, electrically connected to the second electrical connector and configured for sending one or more control signals to the measuring device and for receiving one or more measurement signals from to the measuring device.

31. The control device of claim 30, wherein the coupling portion comprises a locking mechanism configured to selectively lock a measuring device in a coupled position when coupled to the control device, or to selectively unlock the measuring device, wherein the locking mechanism comprises a Bayonet-type locking mechanism.

32. (canceled)

33. The control device of claim 31, further comprising a switch configured to selectively lock and unlock the locking mechanism, and
wherein selectively locking and unlocking includes one or both of haptic feedback or audible feedback.

34. The control device of claim 30, further comprising a cover configured to cover at least part of the coupling portion, wherein the cover is configured to cover the second electrical connector in the absence of a measuring device coupled to the control device.

35. (canceled)

36. (canceled)

37. (canceled)

38. (canceled)

39. (canceled)

40. (canceled)

41. (canceled)

42. (canceled)

43. The control device of claim 30, wherein the control device is configured to determine one or more of: a presence of a coupled measuring device, an operating status of a coupled measuring device, and a type of a couple measuring device based on an inductive coupling of third coils of the control device and of the measuring device.

44. (canceled)

45. (canceled)

46. (canceled)

47. The control device of claim 30, wherein the ECU comprises functionality to control one or more sensors of a measuring device and to receive measurement signals for the one or more sensors, wherein the one or more sensor include one or more of:
temperature sensor,
a pressure sensor,
an electrical conductivity sensor, and
an optical sensor.

48. (canceled)

49. (canceled)

50. A system for measuring fluid flow, the system comprising:
the measuring device of claim 1; and
a control device comprising:
a housing including a coupling portion configured for receiving a measuring device;
a second electrical connector;
an electronic control unit, ECU, electrically connected to the second electrical connector and configured for sending one or more control signals to the measuring device and for receiving one or more measurement signals from to the measuring device.

51. A method for manufacturing a measuring device, the method comprising:
preparing inner surfaces of a main body of the measuring device for casting of thermoplastic resin;
positioning a PBC of the measuring device relative to the main body;
performing casting of the thermoplastic resin; and
performing curing of the thermoplastic resin.

52. (canceled)
